(19) United States
(12) Patent Application Publication
(10) Pub. No.: US 2025/0209574 A1
(43) Pub. Date: Jun. 26, 2025

(54) INFORMATION PROCESSING DEVICE, INFORMATION PROCESSING METHOD, COMPUTER-READABLE MEDIUM, AND INFORMATION PROCESSING SYSTEM

(71) Applicants: Ryouji YAMAMOTO, Tokyo (JP); Hibiki TATSUNO, Tokyo (JP)

(72) Inventors: Ryouji YAMAMOTO, Tokyo (JP); Hibiki TATSUNO, Tokyo (JP)

(21) Appl. No.: 19/075,281

(22) Filed: Mar. 10, 2025

Related U.S. Application Data
(63) Continuation of application No. PCT/JP2023/032361, filed on Sep. 5, 2023.

(30) Foreign Application Priority Data
Sep. 26, 2022 (JP) 2022-152354
Jul. 31, 2023 (JP) 2023-124018

(51) Int. Cl. G06T 5/50; G06T 7/11; G06T 7/13

(52) U.S. Cl. CPC G06T 5/50; G06T 7/11; G06T 7/13; G06T 2207/20221

(57) ABSTRACT

An information processing device includes a generation unit configured to connect captured images obtained by capturing, by an image capturing device installed in a moving object, a target region including a target object and a part other than the target object while dividing the target region into a plurality of image capturing regions along a moving direction of the moving object, to generate a display screen displaying a composite image including a boundary between the target object and the part other than the target object in the moving direction of the moving object.

### CROSS-REFERENCE TO RELATED APPLICATIONS

The present application is a continuation of International Application No. PCT/JP2023/032361, filed on Sep. 5, 2023 which claims the benefit of priority of the prior Japanese Patent Application No. 2022-152354, filed on Sep. 26, 2022, and the prior Japanese Patent Application No. 2023-124018, filed on Jul. 31, 2023. The contents of which are incorporated herein by reference in their entirety.

### BACKGROUND OF THE INVENTION

### 1. Field of the Invention

The present invention relates to an information processing device, an information processing method, a computer-readable medium, and an information processing system.

### 2. Description of the Related Art

Japanese Patent No. 4551990 describes a method and a device for creating a panoramic image that extends long in a direction of movement and extends wider than a viewing angle of each line camera by repeatedly capturing images with each line camera while a moving object is moving.

### SUMMARY OF THE INVENTION

According to an aspect of the present invention, an information processing device includes a generation means configured to connect captured images obtained by capturing, by an image capturing device installed in a moving object, a target region including a target object and a part other than the target object while dividing the target region into a plurality of image capturing regions along a moving direction of the moving object, to generate a display screen displaying a composite image including a boundary between the target object and the part other than the target object in the moving direction of the moving object.

### BRIEF DESCRIPTION OF THE DRAWINGS

FIG. 1 is a diagram illustrating an example of an overall configuration of a condition inspection system according to an embodiment;

FIG. 2 is a diagram illustrating an example of how a slope condition is inspected using a moving object system according to an embodiment;

FIGS. 3A to 3F are diagrams illustrating a condition of a slope;

FIG. 4 is a diagram illustrating an example of a hardware configuration of a data acquisition device;

FIG. 5 is a diagram illustrating an example of a hardware configuration of an evaluation device and a data management device;

FIG. 6 is a diagram illustrating an example of a functional configuration of a condition inspection system;

FIG. 7 is a conceptual diagram illustrating an example of a condition type management table;

FIG. 8 is a conceptual diagram illustrating an example of a condition type management table;

FIG. 9A is a conceptual diagram illustrating an example of an acquired data management table;

FIG. 9B is a conceptual diagram illustrating an example of a processed data management table;

FIG. 10 is a diagram illustrating a captured image acquired by a moving object system;

FIGS. 11A and 11B are diagrams illustrating a captured image and a ranging image;

FIGS. 12A to 12C are diagrams illustrating a plurality of image capturing regions;

FIG. 13 is a diagram illustrating a moving object system including a plurality of image capturing devices according to an embodiment;

FIG. 14 is a sequence diagram illustrating an example of data acquisition processing using a moving object system;

FIG. 15 is a sequence diagram illustrating an example of processing of generating evaluation target data;

FIGS. 16A and 16B are diagrams illustrating a composite image of a condition inspection system;

FIG. 17 is a diagram illustrating operation on an input/output screen of a condition inspection system;

FIG. 18 is another diagram illustrating operation on an input/output screen of a condition inspection system;

FIGS. 19A and 19B are flowcharts illustrating processing based on the operation illustrated in FIGS. 17 and 18;

FIGS. 20A and 20B are diagrams illustrating an integrated partial image of a condition inspection system;

FIG. 21 is a sequence diagram illustrating a modification to the processing of generating evaluation target data;

FIG. 22 is a sequence diagram illustrating an example of processing of generating a report which is an evaluation result of a slope condition;

FIG. 23 is a flowchart illustrating an example of processing of detecting a slope condition;

FIG. 24 is a sequence diagram illustrating an example of display processing in a condition inspection system;

FIG. 25 is a diagram illustrating operation on a display screen of a condition inspection system;

FIGS. 26A and 26B are flowcharts illustrating processing based on the operation illustrated in FIG. 25;

FIG. 27 is an example of a display screen after the processing illustrated in FIGS. 26A and 26B;

FIG. 28 is a diagram illustrating a modification to the functional configuration of the condition inspection system;

FIGS. 29A and 29B are flowcharts illustrating processing in the modification illustrated in FIG. 28;

FIG. 30 is a diagram illustrating an example of a detection data display screen in the modification illustrated in FIG. 28;

FIG. 31 is a diagram illustrating an example of a map screen in the modification illustrated in FIG. 28;

FIG. 32 is a diagram illustrating an example of how a slope condition is inspected using a moving object system according to a first modification;

FIG. 33 is a diagram illustrating an example of how a slope condition is inspected using a moving object system according to a second modification; and

FIG. 34 is a diagram illustrating an example of how a slope condition is inspected using a moving object system according to a third modification.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity.

However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to confirm a position of a target part in an image captured by an image capturing device installed in a moving object.

Hereinafter, embodiments for carrying out the invention will be described with reference to the drawings. In the description of the drawings, the same elements are denoted by the same reference numerals, and redundant description is omitted.

### First Embodiment

### System Overview

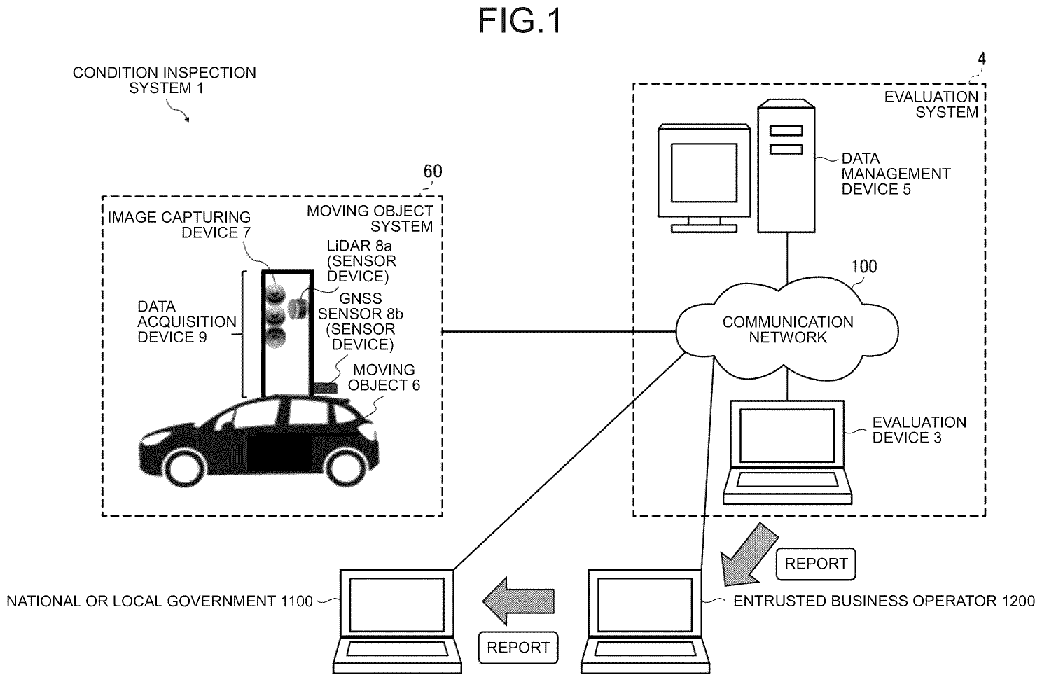

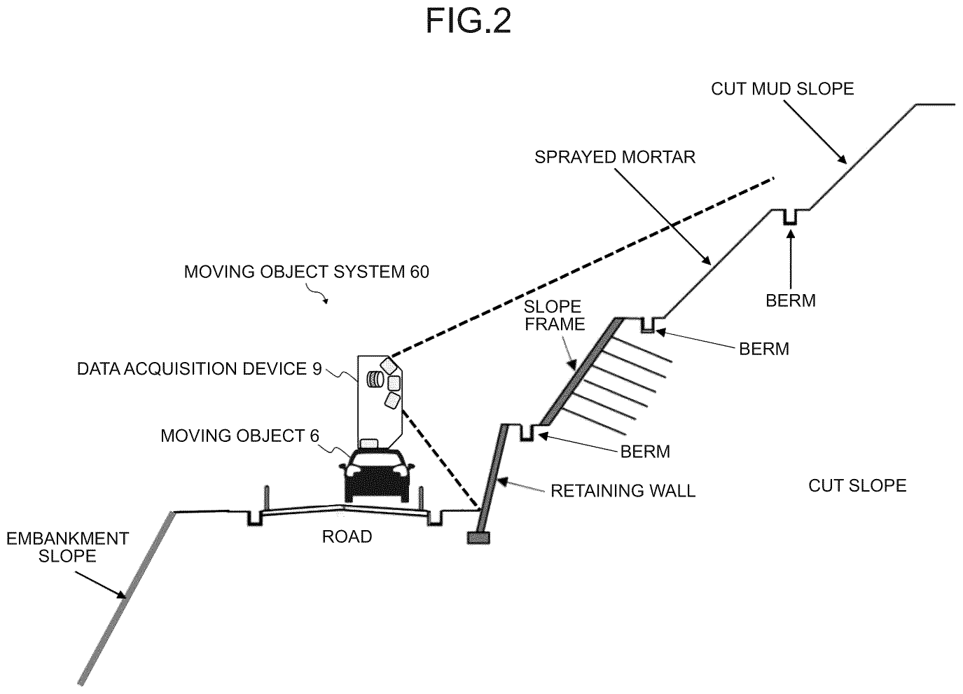

First, an outline of a condition inspection system will be described with reference to FIGS. 1 and 2. FIG. 1 is a diagram illustrating an example of an overall configuration of a condition inspection system according to an embodiment. A condition inspection system 1 illustrated in FIG. 1 is an example of an information processing system, and is a system for inspecting a condition of a road earthwork structure using various data acquired by a moving object system 60. The road earthwork structure is a general term for structures that are mainly made of ground materials such as earth and sand and rocks constructed to build roads, and structures associated therewith, and refers to cut earth and slope stabilization facilities, embankments, culverts, and similar structures. Hereinafter, the road earthwork structure is referred to as a slope.

The condition inspection system 1 includes the moving object system 60, an evaluation system 4, a communication terminal 1100 of a national or local government, and a communication terminal 1200 of an entrusted business operator. The moving object system 60 is an example of an image capturing system, and includes a data acquisition device 9 and a moving object 6 such as a vehicle on which the data acquisition device 9 is mounted. The vehicle may be a vehicle running on a road or a vehicle running on a railway track. The data acquisition device 9 includes an image capturing device 7, which is an example of a measurement device for measuring a structure, a distance sensor 8a, and a global navigation satellite system (GNSS) sensor 8b. GNSS is a general term for satellite positioning systems such as a global positioning system (GPS) or a quasi-zenith satellite system (QZSS).

The image capturing device 7 is a line camera equipped with a line sensor in which photoelectric conversion elements are arranged in one row or a plurality of rows. The image capturing device 7 captures an image of a position along a predetermined image capturing range on an image capturing surface along the traveling direction of the moving object 6. Note that the image capturing device is not limited to the line camera, and may be a camera equipped with an area sensor in which photoelectric conversion elements are arranged in a planar shape. Alternatively, the image capturing device may include a plurality of cameras.

The distance sensor 8a is a time of flight (ToF) sensor, and measures a distance to a subject captured by the image capturing device 7. The GNSS sensor 8b is a positioning means that receives signals transmitted at each time from a plurality of GNSS satellites, and calculates a distance to the satellite based on a difference in the time at which each signal has been received, thereby measuring a position on the earth. The positioning means may be a device dedicated to positioning, or may be an application dedicated to positioning installed on a personal computer (PC), a smartphone, or the like. The distance sensor 8a and the GNSS sensor 8b are examples of sensor devices. The distance sensor 8a is an example of a three-dimensional sensor.

The ToF sensor used as the distance sensor 8a irradiates an object with laser light from a light source to measure the scattered or reflected light to thereby measure a distance from the light source to the object.

In the present embodiment, the distance sensor 8a is a light detection and ranging (LiDAR) sensor. LiDAR is a method of measuring a time of flight of light using a pulse, and as another method of the ToF sensor, the distance may be measured using a phase difference detection method. In the phase difference detection method, a measurement range is irradiated with laser light amplitude-modulated at a fundamental frequency, light reflected therefrom is received, and a phase difference between the irradiated light and the reflected light is measured to obtain time, and a distance is calculated by multiplying the time by a speed of light. Alternatively, the distance sensor 8a may include a stereo camera.

The moving object system 60 can use the three-dimensional sensor to obtain three-dimensional information that is difficult to obtain from a two-dimensional image, for example, the height, the inclination angle, or the bulging of a slope.

In the meantime, the moving object system 60 may further include an angle sensor 8c. The angle sensor 8c is a gyro sensor or the like for detecting an angle (attitude) or an angular velocity (or each acceleration) of the image capturing direction of the image capturing device 7.

The evaluation system 4 is configured with an evaluation device 3 and a data management device 5. The evaluation device 3 and the data management device 5 of the evaluation system 4 are configured to communicate with the moving object system 60, the communication terminal 1100, and the communication terminal 1200 via a communication network 100. The communication network 100 is configured with the Internet, a mobile communication network, a local area network (LAN), or the like. The communication network 100 may include not only wired communication but also a network by wireless communication such as 3rd generation (3G), 4th generation (4G), 5th generation (5G), wireless fidelity (Wi-Fi) (registered trademark), worldwide interoperability for microwave access (WiMAX), or long term evolution (LTE). In addition, the evaluation device 3 and the data management device 5 may have a communication function using a short-range communication technology such as near field communication (NFC) (registered trademark).

The data management device 5 is an example of an information processing device, and is a computer such as a PC that manages various data acquired by the data acquisition device 9. The data management device 5 receives various acquired data from the data acquisition device 9 and passes the received various acquired data to the evaluation device 3 that analyzes data. Note that a method of passing various acquired data from the data management device 5 to the evaluation device 3 may be manual transfer using a universal serial bus (USB) memory or the like.

The evaluation device 3 is a computer such as a PC that evaluates the condition of a slope based on the various acquired data received from the data management device 5. In the evaluation device 3, an application program dedicated to evaluating the slope condition is installed. The evaluation device 3 detects the type or structure of the slope based on data on captured image and sensor data to extract shape data, and performs a detailed analysis by detecting the presence or absence of deformation and a degree of the deformation. The evaluation device 3 also uses the captured image data and the sensor data, evaluation target data, and a result of the detailed analysis to generate a report to be submitted to a road administrator of a national or local government, or an entrusted business operator. Data on the report generated by the evaluation device 3 is submitted to a national or local government via an entrusted business operator in the form of electronic data or the form of being printed on paper. The report generated by the evaluation device 3 is referred to as an investigation record table, an inspection table, an investigation ledger, a record, or the like. The evaluation device 3 is not limited to a PC, and may be a smartphone, a tablet terminal, or the like. In addition, the evaluation system 4 may have a configuration in which the evaluation device 3 and the data management device 5 are configured as one device or terminal.

The communication terminal 1200 is provided to an entrusted business operator, and the communication terminal 1100 is provided to a national or local government. The evaluation device 3, the communication terminal 1100, and the communication terminal 1200 are examples of communication terminals capable of communicating with the data management device 5, and they are configured to browse various data managed by the data management device 5.

FIG. 2 is a diagram illustrating an example of how a slope condition is inspected using a moving object system according to the embodiment. As illustrated in FIG. 2, the moving object system 6 captures a predetermined range of a slope with the image capturing device 7 while causing the moving object 6 equipped with the data acquisition device 9 to travel on a road.

Alternatively, in a case where the position of the slope is unknown, the moving object system 6 causes the moving object 6 to travel several kilometers to several tens of kilometers on the road, and the image capturing device 7 captures images of a predetermined range including the slope and a region other than the slope. The region other than the slope includes an earthwork structure other than the slope, such as a rockfall protection net and a rockfall protection fence, a road, a side road, a natural slope, a traffic light, a sign, a store, the sea (when running along a coastline), and a car.

Here, as illustrated in FIG. 2, among slopes, a slope that has been excavated is called a cut slope, and a slope that has been filled with soil is called an embankment slope. In a road that runs along the side of a mountain, a slope on a side surface is called a natural slope. Cut slopes and embankment slopes can be made more durable by planting plants on the surface of the slope, and can be left unchanged for several decades. However, this is not always the case. In a case where cut slopes, embankment slopes, and natural slopes deteriorate due to wind and rain or the like, surface layer collapse occurs in which rocks and soil on the surface falls, or a landslide leading to road blockages occurs. In order to avoid such situations, a method of spraying mortar on the surface of the slope (mortar spraying) or installing and hardening concrete structures to reduce the speed at which the slope deteriorates when the slope is exposed to wind and rain is adopted. A structure constructed using such a method is called an earthwork structure. Earthwork structures include a retaining wall installed between a natural slope and a road, and a rockfall protection fence for preventing rocks from falling onto the road, and all of them are intended to prevent a road blockage or human injury caused by outflow of earth and sand, rockfall, and the like onto the road.

In recent years, deterioration of earthwork structures built several decades ago has become remarkable, and development of social infrastructure has become a major issue. It is therefore important to early find the deterioration of earthwork structures and to conduct inspections and keep the earthwork structures in good conditions in order to prolong the earthwork structures. Conventional inspections of natural slopes and earthwork structures have been carried out through a visual inspection by an expert and involve investigating rockfall, collapses, landslides, or debris flows on the slopes to create repair plans.

However, the visual inspections by an expert have problems with efficiency, for example, a problem that a large number of earthwork structures throughout Japan cannot be inspected in a certain period of time and a problem that embankments and the like at high locations and along rivers cannot be inspected. Further, in the visual inspections, the degree of deformation such as cracks or peeling occurring on the surface layer of earthwork structures cannot be quantitatively grasped.

To address this, the condition inspection system 1 according to the embodiment acquires data on a captured image of an earthwork structure slope using the image capturing device 7, and acquires sensor data including three-dimensional information using a three-dimensional sensor such as the distance sensor 8a. Then, the evaluation system 4 combines the captured image data and the sensor data thus acquired to evaluate the slope condition, thereby detecting shape data indicating the three-dimensional shape of the slope and detecting deformation such as cracks and peeling. This enables the condition inspection system 1 to efficiently perform evaluation that is difficult to visually inspect by a human.

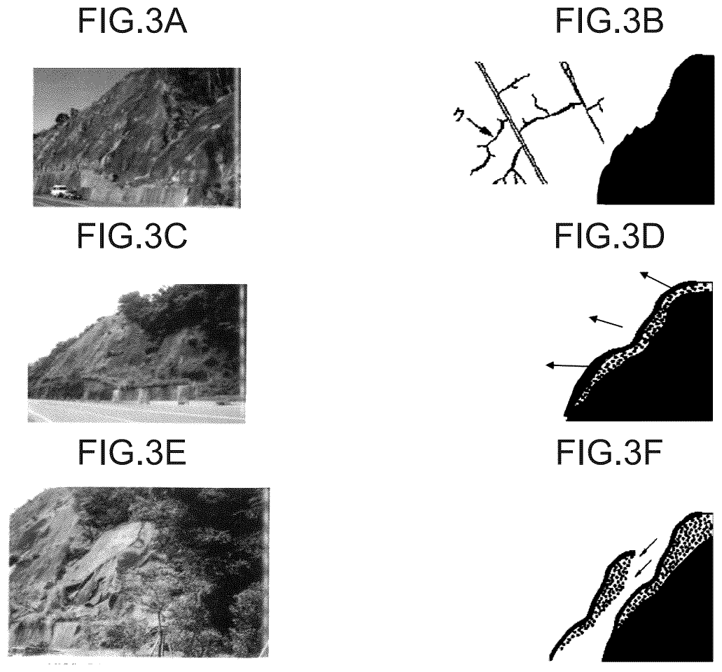

FIGS. 3A to 3F are diagrams illustrating conditions of slopes. FIG. 3A is an image illustrating a surface of a slope five years before collapse, and FIG. 3B is an explanatory diagram of the image illustrated in FIG. 3A. At this stage, cracks in the surface layer of the slope are noticeable, and an image analysis shown in a development view or the like is effective in order to detect deformation or a sign of deformation in the surface layer such as cracks, peeling, and seepage.

FIG. 3C is an image illustrating a surface of a slope two years before collapse, and FIG. 3D is an explanatory diagram of the image illustrated in FIG. 3C. At this stage, the inside of the slope is turned into earth and sand, the earth and sand push against the surface layer of the slope, and the slope is bulged. In order to detect three-dimensional deformation such as a step with a crack and bulging, a three-dimensional analysis using an image of a development view and the like plus a cross-sectional view and the like is effective.

FIG. 3D is an image illustrating a surface of a slope five years before collapse, and FIG. 3B is an explanatory diagram of the image illustrated in FIG. 3A. At this stage, the surface layer of the slope is unable to prevent the earth and sand from moving and is collapsed.

### Hardware Configuration

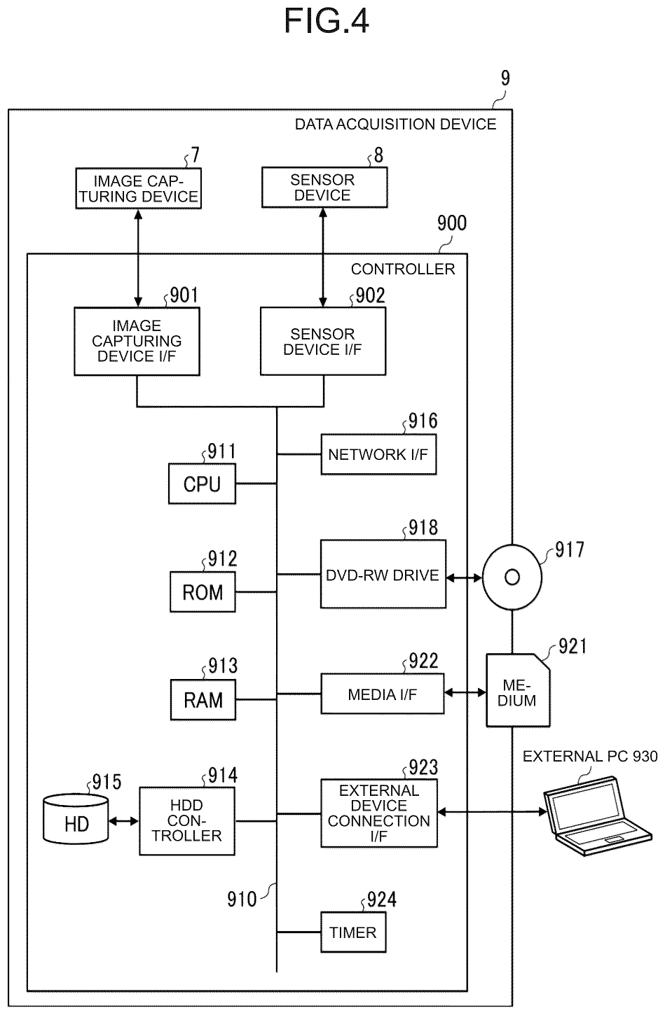

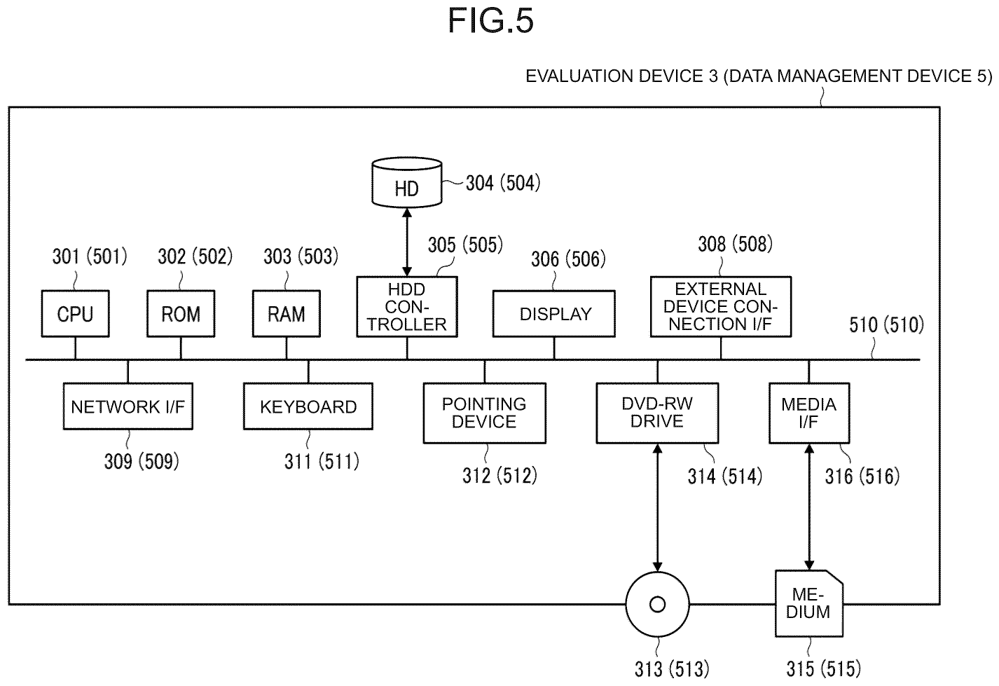

Next, a hardware configuration of each device of the condition inspection system 1 will be described with reference to FIGS. 4 and 5. Note that, in the hardware configuration illustrated in FIGS. 4 and 5, elements may be added or deleted as necessary.

### Hardware Configuration of Data Acquisition Device

FIG. 4 is a diagram illustrating an example of a hardware configuration of a data acquisition device. The data acquisition device 9 includes a controller 900 that controls processing or operation of the data acquisition device 9 together with the image capturing device 7 and a sensor device 8 as illustrated in FIG. 1.

The controller 900 includes an image capturing device interface (I/F) 901, a sensor device I/F 902, a bus line 910, a central processing unit (CPU) 911, a read only memory (ROM) 912, a random access memory (RAM) 913, a hard disk (HD) 914, a hard disk drive (HDD) controller 915, a network I/F 916, a digital versatile disk rewritable (DVD-RW) drive 918, a media I/F 922, an external device connection I/F 923, and a timer 924.

Among them, the image capturing device I/F 901 is an interface for transmitting and receiving various data or information to and from the image capturing device 7. The sensor device I/F 902 is an interface for transmitting and receiving various data or information to and from the sensor device 8. The bus line 910 is an address bus, a data bus, or the like for electrically connecting each element such as the CPU 911 illustrated in FIG. 4.

The CPU 911 controls the operation of the entire data acquisition device 9. The ROM 912 stores a program used for driving the CPU 911 such as an IPL. The RAM 913 is used as a work area of the CPU 911. The HD 914 stores various data such as programs. The HDD controller 915 controls reading or writing of various data from or to the HD 914 under the control of the CPU 911. The network I/F 916 is an interface for data communication using the communication network 100.

The DVD-RW drive 918 controls reading or writing of various data from or to the DVD-RW 917 as an example of a detachable recording medium. Note that the medium is not limited to the DVD-RW and may be a DVD-R, a Blu-ray (registered trademark) disc, or the like.

The media I/F 922 controls reading or writing (storing) of data from or to a recording medium 921 such as a flash memory. The external device connection I/F 923 is an interface for connecting an external device such as an external PC 930 having a display, a receiving unit, and a display control unit. The timer 924 is a measurement device having a time measurement function. The timer 924 may be a computer-based software timer. The timer 924 is preferably synchronized with the time of the GNSS sensor 8b. This makes it easy to synchronize the time and correlate the positions in the sensor data and the captured image data.

### Hardware Configuration of Evaluation Device

FIG. 5 is a diagram illustrating an example of a hardware configuration of an evaluation device. Each hardware configuration of the evaluation device 3 is indicated by a reference numeral in the 300 series. As illustrated in FIG. 5, the evaluation device 3 is configured with a computer, and as illustrated in FIG. 5, the evaluation device 3 includes a CPU 301, a ROM 302, a RAM 303, an HD 304, an HDD controller 305, a display 306, an external device connection I/F 308, a network I/F 309, a bus line 310, a keyboard 311, a pointing device 312, a DVD-RW drive 314, and a media I/F 316.

Among them, the CPU 301 controls the operation of the entire evaluation device 3. The ROM 302 stores a program used for driving the CPU 301 such as an IPL. The RAM 303 is used as a work area of the CPU 301. The HD 304 stores various data such as programs. The HDD controller 305 controls reading or writing of various data from or to the HD 304 under the control of the CPU 301. The display 306 displays various types of information such as a cursor, a menu, a window, a character, or an image. The display 306 is an example of a display unit. The external device connection I/F 308 is an interface for connecting various external devices. The external device in this case is, for example, a USB memory, a printer, or the like. The network I/F 309 is an interface for data communication using the communication network 100. The bus line 310 is an address bus, a data bus, or the like for electrically connecting each element such as the CPU 301 illustrated in FIG. 5.

The keyboard 311 is a type of an input means including a plurality of keys with which to input characters, numerical values, various instructions, and so on. The pointing device 312 is a type of an input means with which to select and execute various instructions, select a processing target, move a cursor, and so on. The DVD-RW drive 314 controls reading or writing of various data from or to the DVD-RW 313 as an example of a detachable recording medium. Note that the medium is not limited to the DVD-RW and may be a DVD-R, a Blu-ray disc, or the like. The media I/F 316 controls reading or writing (storing) of data from or to a recording medium 315 such as a flash memory.

### Hardware Configuration of Data Management Device

FIG. 5 is a diagram illustrating an example of a hardware configuration of a data management device. Each hardware configuration of the data management device 5 is indicated by a reference numeral in the 500 series in parentheses. As illustrated in FIG. 5, the data management device 5 is configured with a computer, and as illustrated in FIG. 5, the data management device 5 has the same configuration as that of the evaluation device 3, and therefore the description of each hardware configuration is omitted. Note that the communication terminals 1100 and 1200 are each also configured with a computer and has the same configuration as that of the evaluation device 3, and the description of each hardware configuration is omitted.

Each of the above programs may be recorded in a computer-readable recording medium as a file in the form of an installable or executable format and distributed. Examples of the recording medium include a compact disc recordable (CD-R), a digital versatile disk (DVD), a Blu-ray disc, an SD card, and a USB memory. In addition, the recording medium can be provided to domestic or foreign countries as a program product. For example, the evaluation system 4 according to the embodiment implements the evaluation method according to the present invention by executing the program according to the present invention.

### Functional Configuration

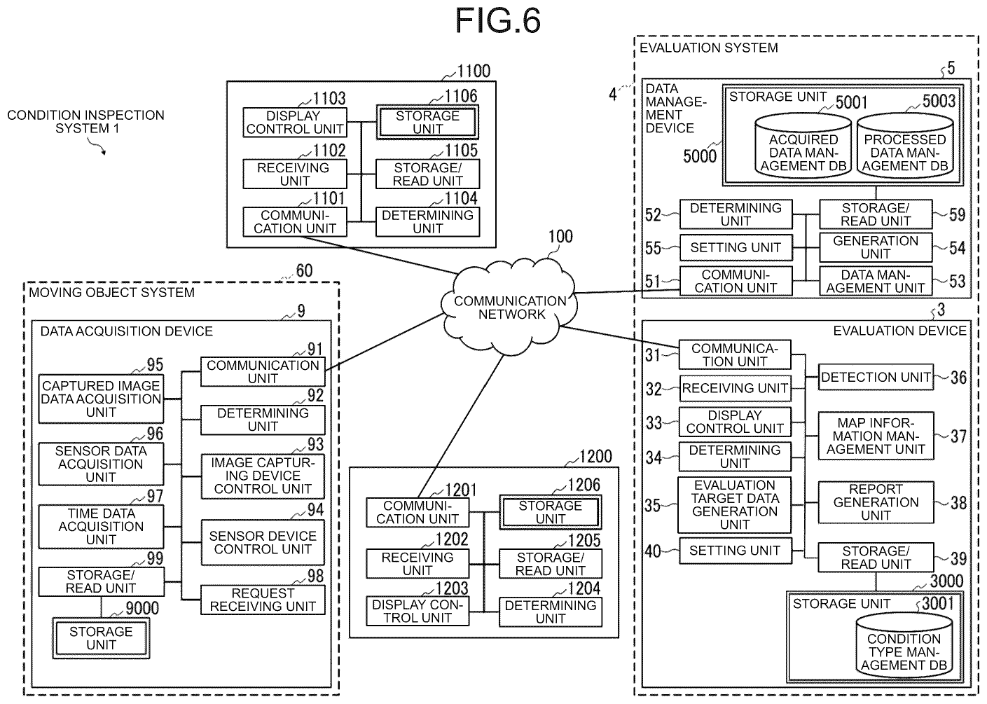

Next, a functional configuration of the condition inspection system according to the embodiment will be described with reference to FIG. 6. FIG. 6 is a diagram illustrating an example of a functional configuration of the condition inspection system according to the first embodiment. Note that FIG. 6 illustrates, among the devices illustrated in FIG. 1, devices related to processing or operation described later.

### Functional Configuration of Data Acquisition Device

First, a functional configuration of the data acquisition device 9 will be described with reference to FIG. 6. The data acquisition device 9 includes a communication unit 91, a calculation unit 92, an image capturing device control unit 93, a sensor device control unit 94, a captured image data acquisition unit 95, a sensor data acquisition unit 96, a time data acquisition unit 97, a request receiving unit 98, and a storage/read unit 99. Each of these units is a function or a means implemented in response to any one of the elements illustrated in FIG. 4 operating based on a command from the CPU 911 according to a program for data acquisition device loaded from the HD 914 onto the RAM 913. In addition, the data acquisition device 9 includes a storage unit 9000 configured with the ROM 912 and the HD 914 illustrated in FIG. 4. The external PC 930, illustrated in FIG. 4, connected to the data acquisition device 9 includes a receiving unit and a display control unit.

The communication unit 91 is mainly implemented by processing of the CPU 911 on the network I/F 916, and communicates various data or information with other devices via the communication network 100. For example, the communication unit 91 transmits, to the data management device 5, the acquired data acquired by the captured image data acquisition unit 95 and the sensor data acquisition unit 96. The calculation unit 92 is implemented by processing of the CPU 911 and performs various calculations.

The image capturing device control unit 93 is mainly implemented by processing of the CPU 911 on the image capturing device I/F 901, and controls image capturing processing by the image capturing device 7. The sensor device control unit 94 is mainly implemented by processing of the CPU 911 on the sensor device I/F 902, and controls data acquisition processing for the sensor device 8. The image capturing device control unit 93 is an example of an angle changing unit.

The captured image data acquisition unit 95 is mainly implemented by the processing of the CPU 911 on the image capturing device I/F 901, and acquires captured image data related to an image captured by the image capturing device 7. The sensor data acquisition unit 96 is mainly implemented by processing of the CPU 911 on the sensor device I/F 902, and acquires sensor data which is a detection result by the sensor device 8. The sensor data acquisition unit 96 is an example of a distance information acquisition unit and a position information acquisition unit. The time data acquisition unit 97 is mainly implemented by processing of the CPU 911 on the timer 924, and acquires time data indicating the time when the data is acquired by the captured image data acquisition unit 95 or the sensor data acquisition unit 96.

The request receiving unit 98 is mainly implemented by processing of the CPU 911 on the external device connection I/F 923, is implemented by processing of the CPU 911, and receives a predetermined request from the external PC 930 or the like.

The storage/read unit 99 is mainly implemented by processing of the CPU 911, and stores various data (or information) in the storage unit 9000 and reads various data (or information) from the storage unit 9000.

### Functional Configuration of Evaluation Device

Next, a functional configuration of the evaluation device 3 will be described with reference to FIG. 6. The evaluation device 3 includes a communication unit 31, a receiving unit 32, a display control unit 33, a determining unit 34, an evaluation target data generation unit 35, a detection unit 36, a map data management unit 37, a report generation unit 38, and a storage/read unit 39. Each of these units is a function or a means implemented in response to any one of the elements illustrated in FIG. 5 operating based on a command from the CPU 301 according to a program for evaluation device loaded from the HD 304 onto the RAM 303. In addition, the evaluation device 3 includes a storage unit 3000 configured with the ROM 302 and the HD 304 illustrated in FIG. 5.

The communication unit 31 is mainly implemented by processing of the CPU 301 on the network I/F 309, and communicates various data or information with other devices via the communication network 100. The communication unit 31 transmits and receives various data related to the evaluation of the slope condition to and from the data management device 5, for example.

The receiving unit 32 is mainly implemented by processing of the CPU 301 on the keyboard 311 or the pointing device 312, and receives various selections or inputs from a user. The receiving unit 32 receives various selections or inputs on an evaluation screen 400 to be described later. The display control unit 33 is mainly implemented by processing of the CPU 301, and causes the display 306 to display various images. The display control unit 33 causes the display 306 to display the evaluation screen 400 to be described later. The determining unit 34 is implemented by processing of the CPU 301 and performs various determinations. The receiving unit 32 is an example of an operation receiving means.

The evaluation target data generation unit 35 is implemented by processing of the CPU 301 and generates data on an evaluation target. The detection unit 36 is mainly implemented by processing of the CPU 301, and performs processing of detecting the slope condition using the evaluation target data generated by the evaluation target data generation unit 35. The map data management unit 37 is mainly implemented by processing of the CPU 301, and manages map information acquired from an external server or the like. The map information includes position information on any position on the map.

The report generation unit 38 is mainly implemented by processing of the CPU 301, and generates an evaluation report to be submitted to the road administrator based on an evaluation result.

The storage/read unit 39 is mainly implemented by processing of the CPU 301, and stores various data (or information) in the storage unit 3000 and reads various data (or information) from the storage unit 3000. A setting unit 40 is mainly implemented by processing of the CPU 301 and performs various settings.

### Functional Configuration of Data Management Device

Next, a functional configuration of the data management device 5 will be described with reference to FIG. 6. The data management device 5 includes a communication unit 51, a determining unit 52, a data management unit 53, and a storage/read unit 59. Each of these units is a function or a means implemented in response to any one of the elements illustrated in FIG. 5 operating based on a command from the CPU 501 according to a program for data management device loaded from the HD 504 onto the RAM 503. In addition, the data management device 5 includes a storage unit 5000 configured with the ROM 502 and the HD 504 illustrated in FIG. 5.

The communication unit 51 is mainly implemented by processing of the CPU 501 on the network I/F 509, and communicates various data or information with other devices via the communication network 100. The communication unit 51 receives, for example, captured image data and sensor data transmitted from the data acquisition device 9. The communication unit 51 transmits and receives various data related to the evaluation of the slope condition and so on to and from the evaluation device 3 and so on, for example. The communication unit 51 is an example of an instruction receiving means. The determining unit 52 is an example of a position generation means, and implemented by processing of the CPU 501 and performs various determinations.

The data management unit 53 is mainly implemented by processing of the CPU 501, and manages various data related to the evaluation of the slope condition. For example, the data management unit 53 registers, in an acquired data management DB 5001, the captured image data and the sensor data transmitted from the data acquisition device 9. The data management unit 53 also registers, for example, data processed or generated by the evaluation device 3 in a processed data management DB 5003. A generation unit 54 is mainly implemented by processing of the CPU 501, and generates various types of image data related to the slope. A setting unit 55 is mainly implemented by processing of the CPU 501 and performs various settings.

The storage/read unit 59 is mainly implemented by processing of the CPU 501, and stores various data (or information) in the storage unit 5000 and reads various data (or information) from the storage unit 5000.

### Functional Configuration of Terminal Device

Next, a functional configuration of the communication terminal 1100 will be described with reference to FIG. 6. The communication terminal 1100 includes a communication unit 1101, a receiving unit 1102, a display control unit 1103, a determining unit 1104, and a storage/read unit 1105. Each of these units is a function or a means implemented in response to any one of the elements illustrated in FIG. 5 operating based on a command from the CPU according to a program for terminal device loaded from the HD onto the RAM. In addition, the data management device 5 includes a storage unit 1106 configured with the ROM and the HD illustrated in FIG. 5.

The communication unit 1101 is mainly implemented by processing of the CPU on the network I/F, and communicates various data or information with other devices via the communication network 100.

The receiving unit 1102 is mainly implemented by processing of the CPU on the keyboard or the pointing device, and receives various selections or inputs from the user. The display control unit 1103 is mainly implemented by processing of the CPU, and causes the display to display various images. The determining unit 1104 is implemented by processing of the CPU 301 and performs various determinations. The receiving unit 1102 is an example of the operation receiving means.

The storage/read unit 1105 is mainly implemented by processing of the CPU, and stores various data (or information) in the storage unit 1106 and reads various data (or information) from the storage unit 1106.

Next, a functional configuration of the communication terminal 1200 will be described with reference to FIG. 6. The communication terminal 1200 includes a communication unit 1201, a receiving unit 1202, a display control unit 1203, a determining unit 1204, and a storage/read unit 1205. Each of these units is a function or a means implemented in response to any one of the elements illustrated in FIG. 5 operating based on a command from the CPU according to a program for terminal device loaded from the HD onto the RAM. In addition, the data management device 5 includes a storage unit 1206 configured with the ROM and the HD illustrated in FIG. 5.

The communication unit 1201 is mainly implemented by processing of the CPU on the network I/F, and communicates various data or information with other devices via the communication network 100.

The receiving unit 1202 is mainly implemented by processing of the CPU on the keyboard or the pointing device, and receives various selections or inputs from the user. The display control unit 1203 is mainly implemented by processing of the CPU, and causes the display to display various images. The determining unit 1204 is implemented by processing of the CPU 301 and performs various determinations.

The storage/read unit 1205 is mainly implemented by processing of the CPU, and stores various data (or information) in the storage unit 1206 and reads various data (or information) from the storage unit 1206.

### Condition Type Management Table

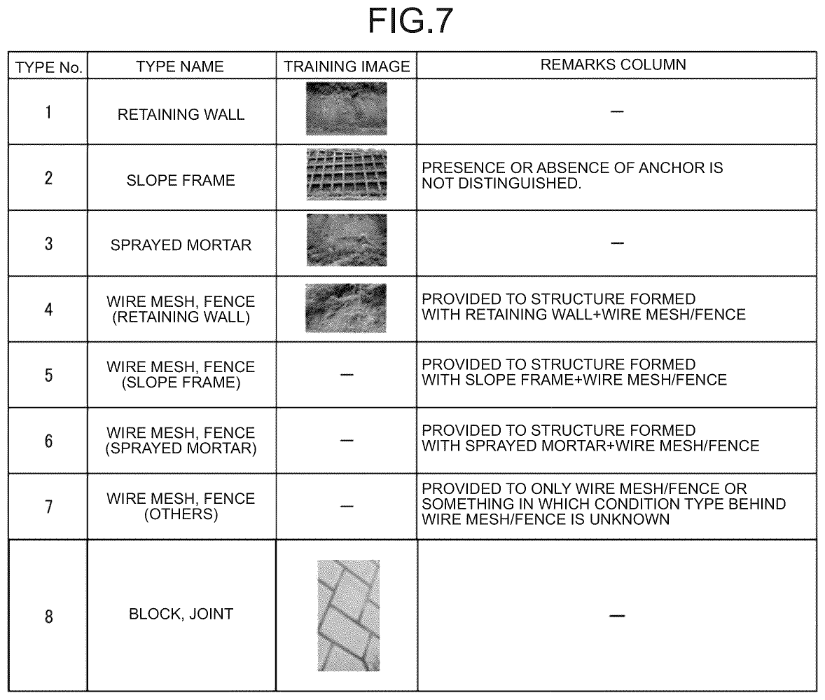

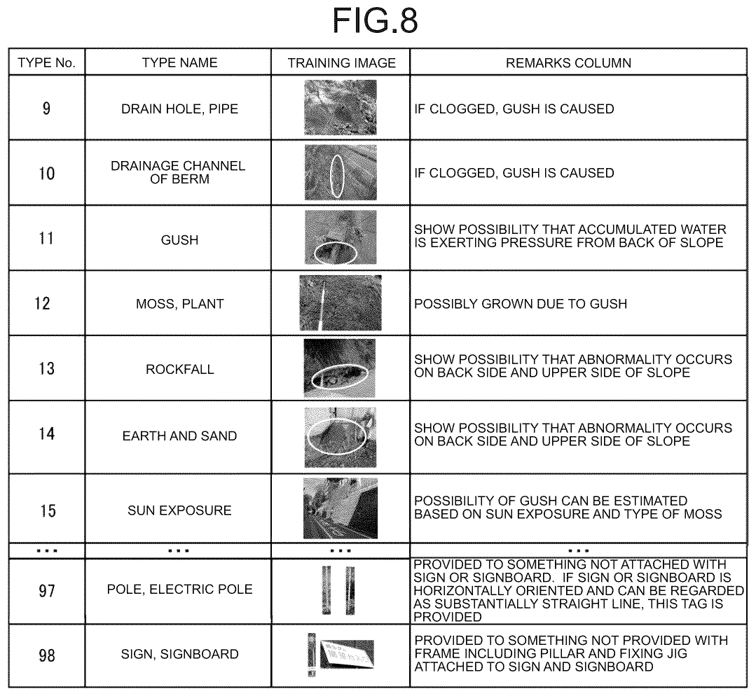

FIGS. 7 and 8 are conceptual diagrams illustrating an example of a condition type management table. The condition type management table is a table for managing training data with which to detect the condition type of a slope. In the storage unit 3000, a condition type management DB 3001 including the condition type management tables as illustrated in FIGS. 7 and 8 is configured. In the condition type management table, a type name indicating a condition type, a training image, and a remarks column are associated and managed for each type number.

Among these, the type name is a name indicating a condition type for identifying a slope, a physical quantity around the slope, and a condition of site information. Here, the condition type includes a type of a slope itself which is a structure such as a retaining wall, a slope frame, a sprayed mortar, a wire mesh, a fence, a drain hole, a pipe, and a drainage channel of a berm, and a type indicating a physical quantity around the slope such as gush, moss, plants, rockfall, earth and sand, and sun exposure. The condition type also includes a type, e.g., a pole, an electric pole, a sign, or a signboard, as site information for supporting data acquisition by the moving object system 60. Further, the condition type may include, as additional information on the structure, information on markers such as chalking indicating the presence of deformation, installed at the time of past inspection or construction, and man-made objects such as a measurement device or a trace of a countermeasure. The training image is an example of training data, and is a training image used in machine learning for determining a slope, a physical quantity around the slope, and a condition type of site information from the captured image data. Here, the training data is not limited to a luminance image, an RGB image, or the like, which is generally called an image. The training data may be any data including information for determination of a condition type, and may be in the form of depth information, text, audio, or the like. In the remarks column, information serving as a detection criterion for detecting a condition type is shown.

Acquired Data Management Table

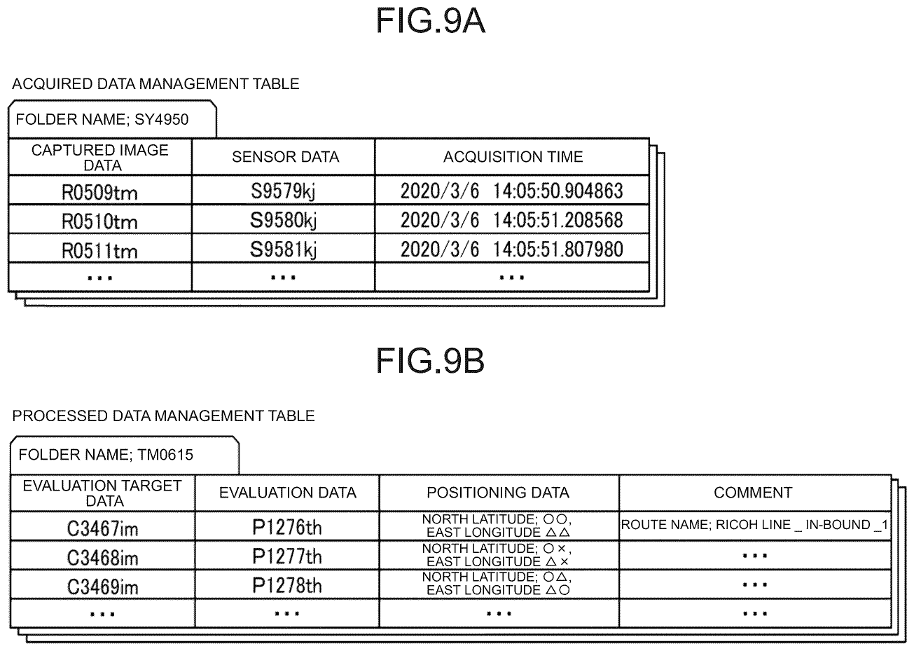

FIG. 9A is a conceptual diagram illustrating an example of an acquired data management table. The acquired data management table is a table for managing various types of acquired data acquired by the data acquisition device 9. In the storage unit 5000, the acquired data management DB 5001 including the acquired data management table as illustrated in FIG. 9A is configured. In the acquired data management table, the captured image data, the sensor data, and the acquisition time are managed in association with each other for each folder.

Among them, the captured image data and the sensor data are data files of acquired data transmitted from the data acquisition device 9. The acquisition time indicates the time when the captured image data and the sensor data have been acquired by the data acquisition device 9. Data acquired in one inspection process is stored in the same folder. The captured image data and three-dimensional sensor data included in the sensor data are stored in correlation with coordinates as described later. The captured image data and the three-dimensional sensor data included in the sensor data are stored in correlation with positioning data included in the sensor data. As a result, when any position in the map information managed by the map data management unit 37 of the evaluation device 3 is selected, the captured image data and the three-dimensional sensor data on the selected position can be read from the acquired data management DB 5001.

### Processed Data Management Table

FIG. 9B is a conceptual diagram illustrating an example of a processed data management table. The processed data management table is a table for managing various types of processed data processed by the evaluation device 3. In the storage unit 5000, the processed data management DB 5003 including the processed data management table as illustrated in FIG. 9B is configured. In the processed data management table, the evaluation target data, the evaluation data, the positioning data, and a comment are managed in association with each other for each folder.

Among them, the evaluation target data is a data file used for detection and evaluation of the slope condition by the evaluation device 3. The evaluation data is a data file indicating an evaluation result by the evaluation device 3. The positioning data is data indicating position information measured by the GNSS sensor 8b. In addition, the comment is bibliographic information input by an evaluator for the evaluation target data or the evaluation data. As a result, when any position in the map information managed by the map data management unit 37 of the evaluation device 3 is selected, the evaluation data on the selected position can be read from the processed data management DB 5003.

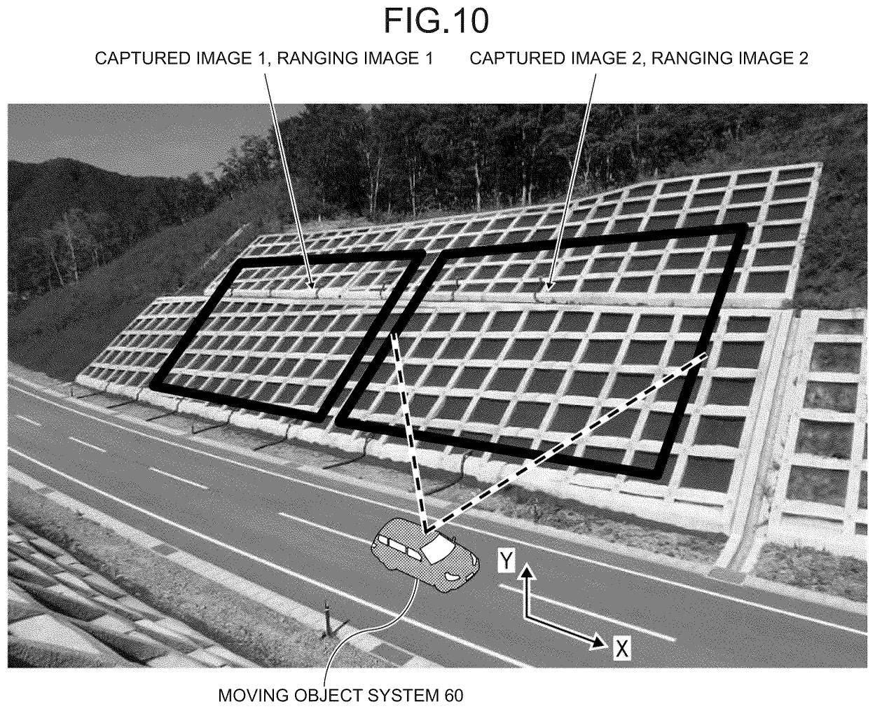

FIG. 10 is a diagram illustrating a captured image acquired by a moving object system.

The moving object system 60 captures an image of a slope provided on a road using the image capturing device 7 provided in the data acquisition device 9 while causing the moving object 6 to travel. An X-axis direction illustrated in FIG. 10 indicates a moving direction of the moving object 6, a Y-axis direction indicates a vertical direction, and a Z-axis direction indicates a depth direction orthogonal to the X-axis direction and the Y-axis direction and a direction from the moving object 6 toward the slope.

As the moving object 6 travels, the data acquisition device 9 acquires a captured image 1 and a ranging image 1, and a captured image 2 and a ranging image 2 in time series as illustrated in FIG. 10. The ranging image 1 and the ranging image 2 are images acquired by the distance sensor 8a. At this time, the image capturing device 7 and the sensor device 8 are time-synchronized, and the captured image 1 and the ranging image 1 are images for the same region of the slope, and the captured image 2 and the ranging image 2 are images for the same region of the slope. In addition, inclination correction (image correction) of the captured image is performed based on the attitude of the vehicle at the time of image capturing, and the image data and the positioning data (north latitude and east longitude) are correlated based on the time of the captured image.

As described above, the moving object system 60 acquires the captured image data obtained by capturing an image of the slope and the sensor data obtained in response to the image capturing by the image capturing device 7 while causing the vehicle as the moving object 6 to travel, and uploads the acquired data to the data management device 5. Note that the data acquisition device 9 may separately acquire the ranging image and the captured image during different runs, but it is preferable to acquire the ranging image and the captured image during the same run with respect to the same slope shape, in consideration of a change in slope shape due to collapse or the like.

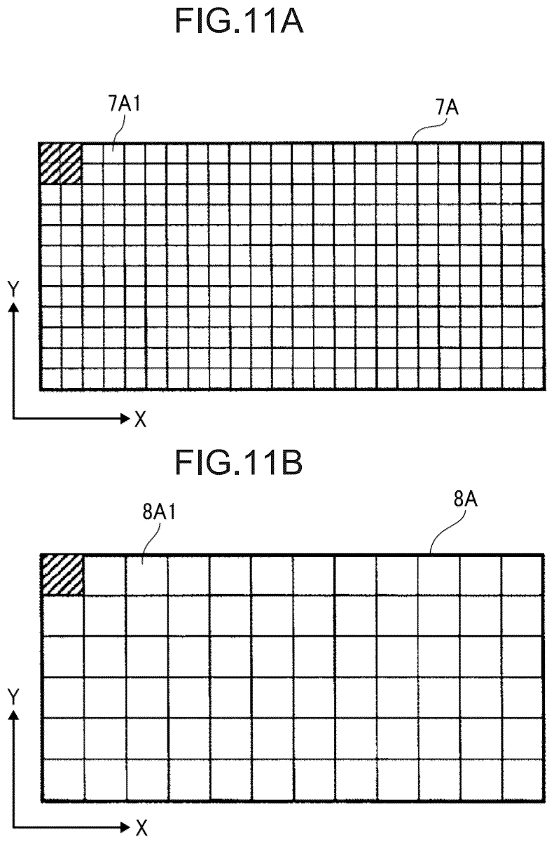

FIGS. 11A and 11B are diagrams illustrating a captured image and a ranging image.

FIG. 11A illustrates captured image data 7A on the captured images 1 and 2 illustrated in FIG. 10 and so on. Pixels 7A1 of the captured image data 7A acquired by the image capturing device 7 are arranged at coordinates corresponding to the X-axis direction and the Y-axis direction illustrated in FIG. 10, and have luminance information corresponding to the amount of stored power. That is, the captured image data 7A is an example of a luminance image.

Then, the luminance information of each pixel 7A1 of the captured image data 7A is stored in the storage unit 5000 as the captured image data illustrated in FIGS. 9A and 9B in correlation with the coordinates corresponding to the X-axis direction and the Y-axis direction illustrated in FIG. 10.

FIG. 11B illustrates ranging image data 8A on the ranging images 1 and 2 illustrated in FIG. 10 and so on. Pixels 8A1 of the ranging image data 8A acquired by the distance sensor 8a are arranged at coordinates corresponding to the X-axis direction and the Y-axis direction illustrated in FIG. 10, and have distance information in the Z-axis direction illustrated in FIG. 10 corresponding to the amount of stored power. Although the ranging image data 8A is three-dimensional point group data, the ranging image data 8A is referred to as ranging image data because, in general, the ranging image data 8A is visually displayed with luminance information given when being visually recognized by a user. The captured image data 7A and the ranging image data 8A are collectively referred to as image data.

Then, the distance information of each pixel 8A1 of the ranging image data 8A is stored in the storage unit 5000 as three-dimensional data included in the sensor data illustrated in FIGS. 9A and 9B in correlation with the coordinates corresponding to the X-axis direction and the Y-axis direction illustrated in FIG. 10.

Here, since the captured image data 7A illustrated in FIG. 11A and the ranging image data 8A illustrated in FIG. 11B are images for the same region of the slope, the luminance information and the distance information are stored in the storage unit 5000 in correlation with the coordinates corresponding to the X-axis direction and the Y-axis direction illustrated in FIG. 10.

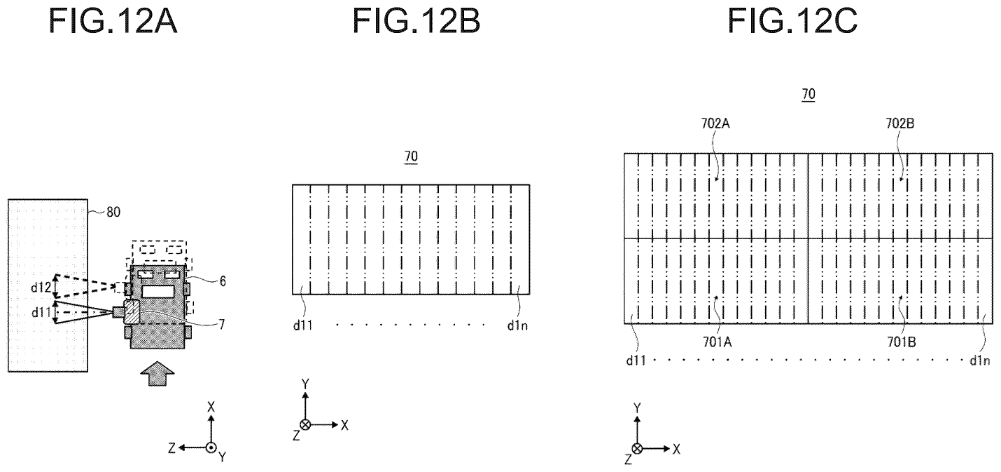

FIGS. 12A to 12C are diagrams illustrating a plurality of image capturing regions. As illustrated in FIG. 12A, the image capturing device 7 captures an image of a slope 80, which is a target object to be inspected and evaluated, while moving together with the moving object 6. Specifically, the image capturing device 7 captures an image of a target region 70 including the slope 80 by dividing the target region 70 into a plurality of image capturing regions d11, d12 ⋅ ⋅ ⋅ at a constant image capturing interval t along the X-axis direction that is the moving direction of the moving object 6.

Here, in a case where the position of the slope 80 in the X-axis direction is unknown, the image capturing device 7 captures an image of the target region 70 including the slope 80 that is an inspection and evaluation target object and a region other than the inspection and evaluation target object with the target region 70 divided into the plurality of the image capturing regions d11, d12 ⋅ ⋅ ⋅ , and a plurality of image capturing regions obtained by capturing images of the slope 80 is identified from the plurality of image capturing regions as described later.

As illustrated in FIG. 12B, the captured image obtained by capturing images of the plurality of image capturing regions d11, d12 ⋅ ⋅ ⋅ is a slit-shaped captured image elongated in the Y-axis direction, and the captured images of the target region 70 continuous in the X-axis direction can be obtained by connecting the images obtained by capturing the plurality of image capturing regions d11, d12 ⋅ ⋅ ⋅ .

FIG. 12C is a diagram illustrating a case where the entire target region 70 is divided into a plurality of target regions and imaged when the entire target region 70 is imaged. In FIG. 12C, the entire target region 70 is imaged with the captured image divided into four target regions of target regions 701A, 702A, 701B, and 702B.

Similarly to the case illustrated in FIG. 12B, each of the plurality of target regions 701A, 702A, 701B, and 702B is divided into the plurality of image capturing regions d11, d12 ⋅ ⋅ ⋅ , and imaged, and the captured images of the plurality of target regions d11, d12 ⋅ ⋅ ⋅ are connected to each other, so that the captured images of the plurality of target regions 701A, 702A, 701B, and 702B can be obtained. Then, the captured images obtained by capturing images of the plurality of target regions 701A, 702A, 701B, and 702B are connected together, whereby the captured image of the target region 70 can be obtained.

In this case, the image capturing device 7 includes a plurality of image capturing devices, and the target regions 702A and 702B are imaged by an image capturing device different from the image capturing device that captures images of the target regions 701A and 701B.

In addition, the target region 701B is imaged by the same image capturing device that images the target region 701A under different image capturing conditions, and the target region 702B is also imaged by the same image capturing device that images the target region 702A under different image capturing conditions.

As illustrated in FIG. 12A, it is desirable that the distance sensor 8a also acquires distance information indicating the distance from the distance sensor 8a to each of the plurality of image capturing regions d11, d12 ⋅ ⋅ ⋅ at the timing when the image capturing device 7 images the target region of the slope 80 with the target region divided into the plurality of image capturing regions d11, d12 ⋅ ⋅ ⋅ .

As a result, as described with reference to FIG. 10, the luminance information of each pixel 7A1 of the captured image data 7A acquired by the image capturing device 7 can be easily correlated with the distance information of each pixel 8A1 of the ranging image data 8A acquired by the distance sensor 8a. Then, the luminance information on each image of the captured images obtained by capturing images of the target region of the slope 80 is correlated with the distance information on each pixel of the ranging image obtained by measuring the distance to the target region of the slope 80, so that the target region of the slope 80 can be inspected with high accuracy.

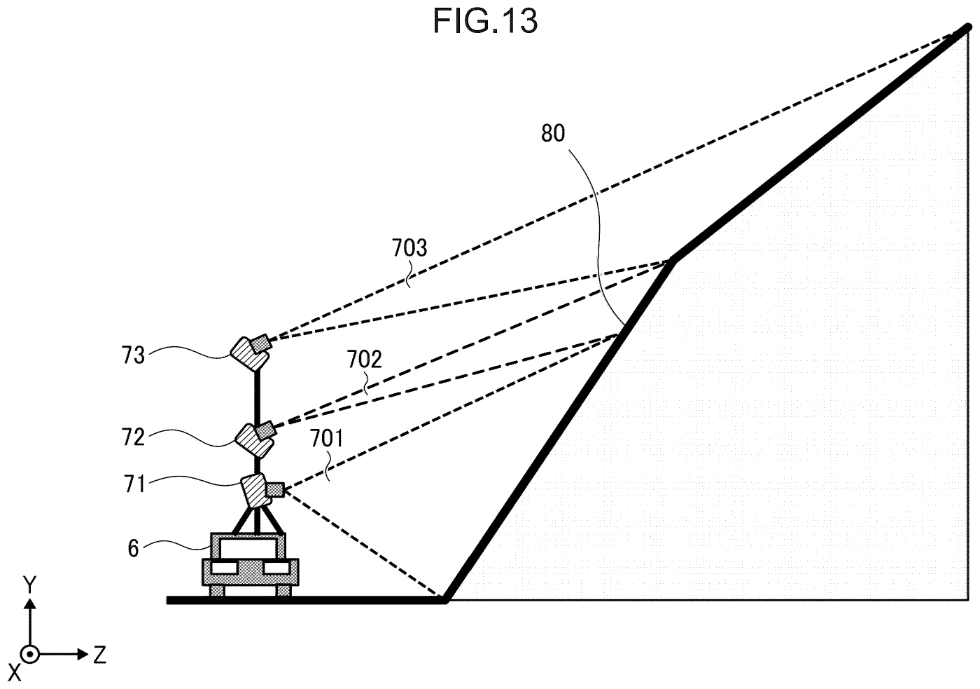

FIG. 13 is a diagram illustrating a moving object system including a plurality of image capturing devices according to the embodiment.

The image capturing device 7 includes a plurality of image capturing devices 71, 72, and 73, and the image capturing devices 71, 72, and 73 capture a target region 701 on the slope 80, a target region 702 above the target region 701, and a target region 703 above the target region 702, respectively.

Here, first and second target regions indicate any two of the target region 701, the target region 702, and the target region 703, and first and second image capturing devices indicate image capturing devices corresponding to the first and second target regions among the plurality of image capturing devices 71, 72, and 73.

### Processing or Operation According to Embodiment

### Data Acquisition Processing

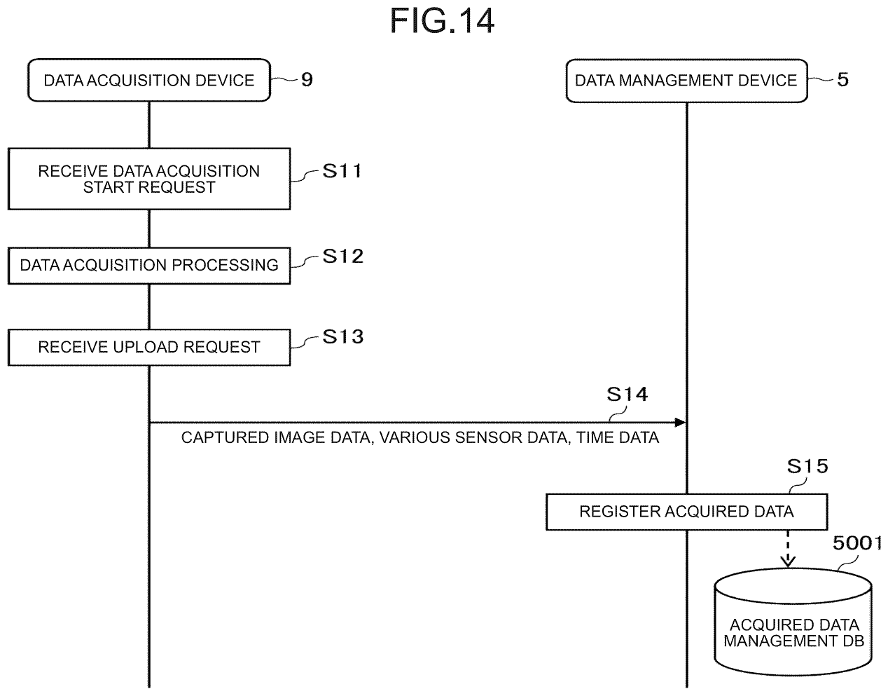

Next, data acquisition processing using the moving object system 60 will be described with reference to FIG. 14. A worker who inspects the slope condition gets on the moving object 6 to take an image of a slope on the road, and uploads the acquired data to the data management device 5. Details will be described below.

FIG. 14 is a sequence diagram illustrating an example of data acquisition processing using a moving object system. First, when the inspection worker performs predetermined input operation or the like on an external PC 330, the request receiving unit 98 of the data acquisition device 9 receives a data acquisition start request (Step S11). The data acquisition device 9 then executes data acquisition processing using the image capturing device 7 and the sensor device 8 (Step S12).

Specifically, the image capturing device control unit 93 starts image capturing processing for a predetermined region by requesting the image capturing device 7 to capture an image.

The position of the slope is not necessarily known. That is, the moving object system 6 causes the image capturing device 7 to capture images of a predetermined region including the slope and a region other than the slope while causing the moving object 6 to travel, and the image capturing device control unit 93 starts the image capturing processing for the region other than the slope, performs the image capturing processing for the slope, and then ends the image capturing processing for the region other than the slope. This enables image capturing of the entire region from one end to the other end of the slope in the moving direction of the moving object 6.

In addition, the sensor device control unit 94 starts detection processing by the distance sensor 8a and the GNSS sensor 8b in synchronization with the image capturing processing by the image capturing device 7. Then, the captured image data acquisition unit 95 acquires the captured image data acquired by the image capturing device 7, and the sensor data acquisition unit 96 acquires the sensor data acquired by the distance sensor 8a and the GNSS sensor 8b. The time data acquisition unit 97 acquires time data indicating the time when various data has been acquired by the captured image data acquisition unit 95 and the sensor data acquisition unit 96.

Next, when the inspection worker performs predetermined input operation or the like on the external PC 330 and the like, the request receiving unit 98 receives a request to upload various data acquired (Step S13). The communication unit 91 then uploads (transmits) the captured image data, the sensor data, and the time data, which are the acquired data acquired in Step S12, to the data management device 5 (Step S14). As a result, the communication unit 51 of the data management device 5 receives the acquired data transmitted from the data acquisition device 9. Then, the data management unit 53 of the data management device 5 registers the acquired data received in Step S14 in the acquired data management DB 5001 (see FIG. 9A) (Step S15).

The data management unit 53 stores the captured image data and the sensor data in one folder in association with the time data indicating the acquisition time of each set of data contained in the acquired data.

### Evaluation Processing of Slope Condition

### Generation of Evaluation Target Data

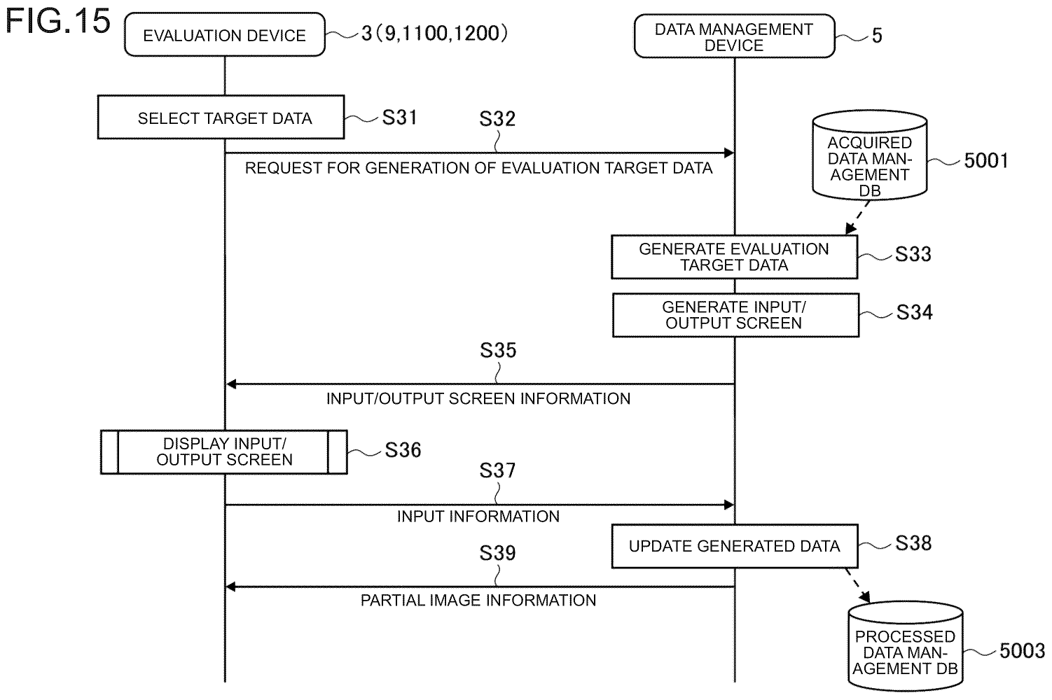

FIG. 15 is a sequence diagram illustrating an example of processing of generating evaluation target data.

Hereinafter, the sequence between the evaluation device 3 and the data management device 5 will be described, and the same applies to the sequence between the data acquisition device 9, the communication terminal 1100 as well as the communication terminal 1200, and the data management device 5.

When a user of the evaluation device 3 designates a folder, the receiving unit 32 of the evaluation device 3 receives selection of generation target data (Step S31). Alternatively, when the user of the evaluation device 3 selects any position in the map information managed by the map data management unit 37 of the evaluation device 3, the receiving unit 32 of the evaluation device 3 may receive the selection of the position information in the map information.

Next, the communication unit 31 transmits a request to generate evaluation target data related to the generation target data selected in Step S11 to the data management device 5, and the communication unit 51 of the data management device 5 receives the request transmitted from the evaluation device 3 (Step S32). The request includes the folder name selected in Step S31. Alternatively, the request may include position information in the map information.

Next, the storage/read unit 59 of the data management device 5 searches the acquired data management DB 5001 using, as a search key, the folder name included in the generation request received in Step S32 to read the acquired data associated with the folder name included in the generation request. Alternatively, the storage/read unit 59 searches the acquired data management DB 5001 using, as a search key, the position information included in the request received in Step S32 to read the acquired data associated with the position information included in the request. The acquired data includes the captured image data, the sensor data, and the time data.

The generation unit 54 of the data management device 5 generates evaluation target data based on the acquired data read out by the storage/read unit 59 (Step S33). Specifically, the generation unit 54 performs inclination correction on the captured image data based on the attitude of the image capturing device 7 (moving object 6) at the time of image capturing based on the acquired sensor data of the distance sensor 8a. In addition, the generation unit 54 correlates the positioning data, which is the acquired sensor data of the GNSS sensor 8b, with the captured image data based on the time data acquired. Further, the generation unit 54 performs processing of combining a plurality of sets of captured image data into one set of image data.

Specifically, as described with reference to FIGS. 12A to 12C, the generation unit 54 generates a composite image in which the captured images of the plurality of image capturing regions are connected, thereby obtaining the captured images of the target region 70 and the plurality of target regions 701A, 702A, 701B, and 702B.

Further, the generation unit 54 generates a composite image in which the captured images of the plurality of target regions 701A, 702A, 701B, and 702B are connected, thereby obtaining the captured image of the entire target region 70.

Here, as described above, the target region 70 includes the slope 80 and a region other than the slope 80.

As described above, the generation unit 54 has an inclination correction function for image data, a function of linking image data with position information, and a function of combining image data. The generation unit 54 uses the acquired data to perform image correction on the acquired captured image data so that the processing by the detection unit 36 and the report generation unit 38, described later, can be easily performed.

Next, the generation unit 54 generates an input/output screen including the composite image (Step S34). The input/output screen is an example of a display screen displaying a composite image in which the images captured by dividing the target region 70 into the plurality of image capturing regions dn along the moving direction of the moving object 6 are connected together, and Step S34 is an example of a generation step.

Here, the generation unit 54 generates a composite image having a resolution lower than that of the composite image generated in Step S33, and generates an input/output screen including the composite image having the lower resolution.

That is, the generation unit 54 generates an input/output screen so as to display a composite image 2500 with a resolution lower than that of each image captured with the target region divided into the plurality of image capturing regions dn stored in the acquired data management DB 5001. This improves the processing speed at the time of generating the input/output screen including the composite image.

In addition, the generation unit 54 generates an input/output screen including a plurality of composite images corresponding to the target regions 701, 702, and 703 imaged by the image capturing devices 71, 72, and 73 described with reference to FIG. 13.

That is, the target region 70 includes a first target region and a second target region which are different ranges in a direction intersecting the moving direction of a moving object 66, and the generation unit 54 generates an input/output screen 2000 including at least one of a first composite image and a second composite image. The first composite image is obtained by connecting the first captured images pn obtained by capturing images with the first target region divided into the plurality of first image capturing regions dn along the moving direction of the moving object 66. The second composite image is obtained by connecting the second captured images pn obtained by capturing images with the second target region divided into the plurality of second image capturing regions dn along the moving direction of the moving object 66.

The communication unit 51 transmits input/output screen information related to the input/output screen generated in Step S34 to the evaluation device 3, and the communication unit 31 of the evaluation device 3 receives the input/output screen information transmitted from the data management device 5 (Step S35).

Here, as described above, since the input/output screen includes the composite image generated with a resolution lower than those of the plurality of captured images stored in the acquired data management DB 5001, the communication load when transmitting the input/output screen including the composite image is reduced.

Next, the display control unit 33 of the evaluation device 3 causes the display 306 to display the input/output screen received in Step S34, and the receiving unit 32 of the evaluation device 3 receives predetermined input operation by the user on the displayed input/output screen (Step S36). The input operation includes determination operation for determining to specify a partial region in the composite image.

Here, as described above, since the input/output screen includes the composite image generated with a resolution lower than those of the plurality of captured images stored in the acquired data management DB 5001, the processing speed when displaying the input/output screen including the composite image is improved.

The communication unit 31 transmits input information related to the input operation received by the receiving unit 32 to the data management device 5, and the communication unit 51 of the data management device 5 receives the input information transmitted from the evaluation device 3 (Step S37). The input information includes specified region information for specifying a partial region in the composite image, a comment, and identification information for identifying a specific slope among a plurality of slopes.

Next, the setting unit 55 updates the evaluation target data generated in Step S33 based on the input information received in Step S37, and stores the resultant in the processed data management DB 5003 (see FIG. 9B) (Step S38). The setting unit 55 is an example of a setting means.

Specifically, the setting unit 55 sets a partial image corresponding to a partial region, position information, and a specified point group in a three-dimensional point group corresponding to the plurality of image capturing regions dn, based on specified region information specifying a partial region in the composite image, thereby updating the evaluation target data and storing, in one folder, the evaluation target data, the positioning data, and the comment included in the generated data in association with each other.

Here, as described above, the composite image included in the input/output screen is an image generated with a resolution lower than those of the plurality of captured images stored in the acquired data management DB 5001. However, since the partial image stored in Step S38 is an image having the same high resolution as those of the plurality of captured images stored in the acquired data management DB 5001, processing by the detection unit 36 and the report generation unit 38 described later can be executed with high accuracy.

Next, the communication unit 51 transmits partial image information indicating the partial image contained in the generated data updated in Step S38 to the evaluation device 3, and the communication unit 31 of the evaluation device 3 receives the partial image information transmitted from the data management device 5 (Step S39). Then, the display control unit 33 of the evaluation device 3 causes the display 306 to display the partial image received in Step S39.

In the above, the functions of the data management device 5 in FIG. 6 may be integrated into the evaluation device 3, and the processing of the data management device 5 in FIG. 15 may also be executed by the evaluation device 3.

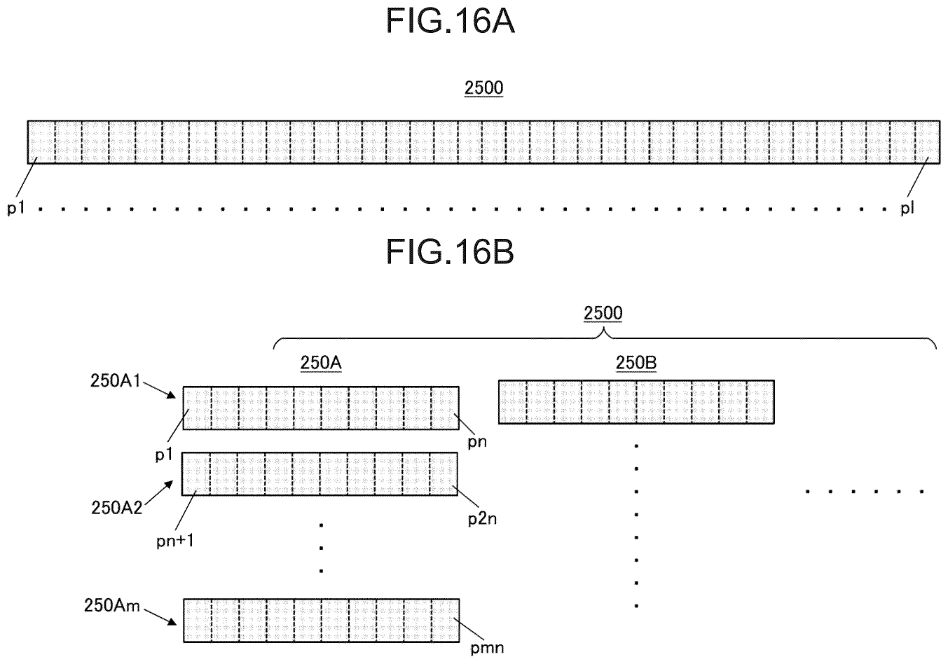

FIGS. 16A and 16B are diagrams illustrating a composite image of a condition inspection system.

FIG. 16A illustrates the composite image 2500 generated in Step S33 of FIG. 15. The composite image 2500 is an image obtained by connecting captured images p1 to p1 obtained by capturing images of the target region 70 divided into the plurality of image capturing regions dn along the moving direction of the moving object 6. As described above, in a case where the position of the slope is unknown, it corresponds to a route of several kilometers to several tens of kilometers, and thus it is difficult to view its entirety.

FIG. 16B illustrates the composite image 2500 contained in the input/output screen generated in Step S34 of FIG. 15.

In Step S34 of FIG. 15, the generation unit 54 generates an input/output screen so as to divide the composite image 2500 into a plurality of divided image groups 250A, 250B ⋅ ⋅ ⋅ , and display divided images of each of a plurality of divided images 250A1 to Am side by side in the divided image groups 250A, 250B ⋅ ⋅ ⋅ . Each divided image of the plurality of divided images 250A1 to Am is an image obtained by connecting the plurality of captured images p1 to pn, pn+1 to p2n ⋅ ⋅ ⋅ .

Here, each of the plurality of divided image groups 250A and 250B indicates a range displayed on one input/output screen, and is switched and displayed on the display 306 or the like, for example. The generation unit 54 preferably performs an image analysis on each of the plurality of divided image groups 250A and 250B, and identifies a location where a boundary between the slope 80 and a part other than the slope 80 in the moving direction of the moving object 6 exists probably.

Further, in Step S34 of FIG. 15, the generation unit 54 generates an input/output screen such that the number of divided image groups 250A, 250B ⋅ ⋅ ⋅ , the number of divided images 250A1 to Am included in one divided image group, and the number of captured images p1 to pn included in one divided image are different according to the resolution of the display 306 or the like on which the input/output screen is displayed.

That is, the generation unit 54 generates an input/output screen such that the length of the composite image 2500 in the moving direction of the moving object 66 corresponding to the moving distance of the moving object 66 is different.

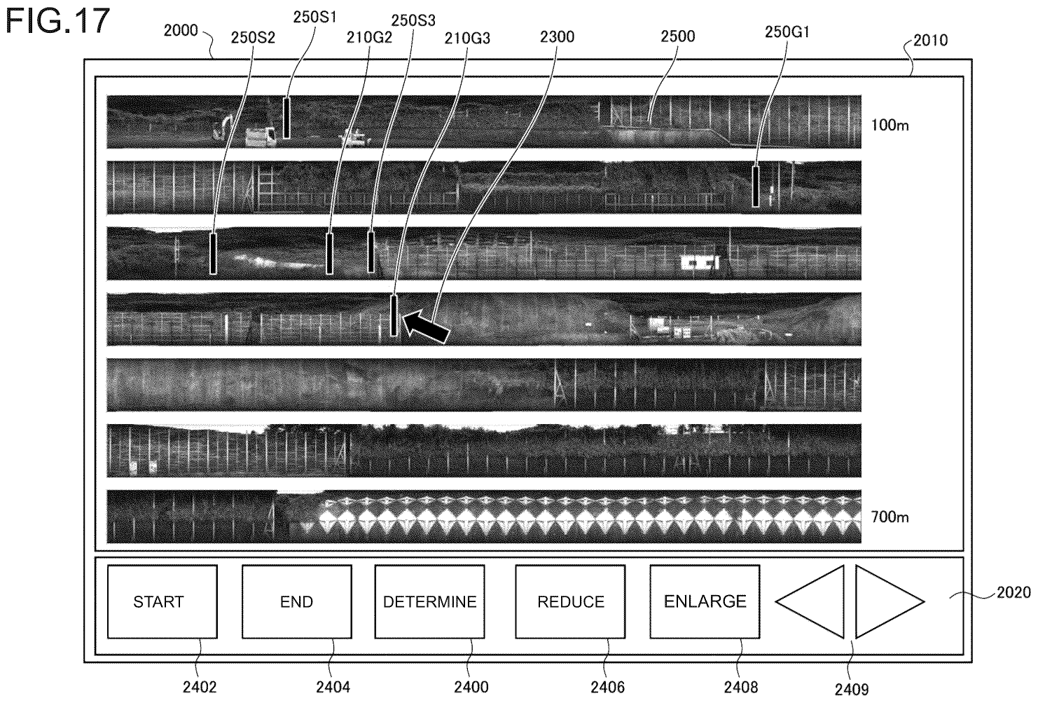

FIG. 17 is a diagram illustrating operation on an input/output screen of a condition inspection system.

FIG. 17 is a diagram illustrating operation on an input/output screen of a condition inspection system. FIG. 17 illustrates the input/output screen 2000 displayed on the display 306 of the evaluation device 3 in Step S36 of the sequence diagram illustrated in FIG. 15, and the same applies to the input/output screen 2000 displayed on each of the displays of the data acquisition device 9, the communication terminal 1100, and the communication terminal 1200.

The display control unit 33 of the evaluation device 3 displays the input/output screen 2000 including a specifying receiving screen 2010 for receiving specifying operation for specifying a partial region in the composite image 2500 and a determination receiving screen 2020 for receiving determination operation for determining to specify the partial region in the composite image 2500.

The display control unit 33 displays the composite image 2500 on the specifying receiving screen 2010 and displays a pointer 2300 operated with the pointing device 312 on the composite image 2500.

As described in Step S34 of FIG. 15, the composite image 2500 is an image obtained by connecting captured images obtained by capturing images of the target region 70 divided into the plurality of image capturing regions dn along the moving direction of the moving object 6, and is displayed as a divided image group in which the divided images of each of the plurality of divided images are arranged as described with reference to FIG. 16A.

In FIG. 17, each divided image indicates a captured image having a route of 100 meters along the moving direction of the moving object 6, and a divided image group in which seven divided images are arranged indicates a captured image having a route of 700 meters along the moving direction of the moving object 6.

The display control unit 33 displays a start position designation button 2402, an end position designation button 2404, a reduce button 2406, and an enlarge button 2408 in the determination receiving screen 2020.

The start position designation button 2402 and the end position designation button 2404 are buttons used to instruct the display of a start position bar 250S and an end position bar 250G, respectively, on the composite image 2500.

The start position bar 250S and the end position bar 250G can be moved to any positions on the composite image 2500 by operating the pointer 2300.

A specified position determination button 2400 is a button used to determine the positions of the start position bar 250S and the end position bar 250G on the composite image 2500.

The reduce button 2406 and the enlarge button 2408 are buttons used to instruct the display of the composite image 2500 to be reduced or enlarged. A screen switching button 2409 is a button used to switch between the display of the plurality of divided image groups 250A and 250B illustrated in FIG. 16B.

In FIG. 17, when the user operates the start position designation button 2402, the receiving unit 32 receives the operation, and the display control unit 33 displays the start position bar 250S at any position on the composite image 2500.

When the user operates the end position designation button 2404, the receiving unit 32 receives the operation, and the display control unit 33 displays the end position bar 250G at any position on the composite image 2500.

When the user operates the pointer 2300 to move the start position bar 250S and the end position bar 250G to the boundary positions on both sides of the slope 80 on the composite image 2500, the receiving unit 32 receives the movement as the specifying operation for specifying a partial region in the composite image 2500. Here, the position information indicating the positions of the start position bar 250S and the end position bar 250G in the composite image 2500 is an example of specified region information for specifying a partial region in the composite image 2500.

When the user operates the specified position determination button 2400, the receiving unit 32 receives the operation as determination operation for determining to specify a partial region in the composite image 2500.

In FIG. 17, on the composite image 2500, a plurality of pairs of start position bars 250S1 to 250S3 and end position bars 250G1 to 250G3 is displayed corresponding to the boundaries on both sides of the plurality of slopes 80 at different positions in the moving direction of the moving object 66.

Here, if the composite image 2500 displays only a region between the start position bar 250S1 and the end position bar 250G1, the user cannot confirm the boundaries on both sides of the slope 80 in the moving direction of the moving object 66, which makes it impossible to accurately confirm the position and range of the slope 80.

In the present embodiment, the generation unit 54 generates the input/output screen 2000 including the composite image 2500 such that the composite image 2500 includes boundaries on both sides of the slope 80 in the moving direction of the moving object 6. This enables the user to confirm the composite image 2500 including the boundaries on both sides of the slope 80 displayed on the input/output screen 2000, and to accurately confirm the position and range of the slope 80. In addition, the display control unit 33 gives, among the plurality of divided image groups 250A and 250B described with reference to FIG. 16B, a higher priority to a divided image group in which a boundary between the slope 80 and a part other than the slope 80 in the moving direction of the moving object 6 probably exists by an image analysis, and displays the resultant on the input/output screen 2000. This reduces unnecessary checking man-hours by the user by displaying the divided image group in which there is no boundary between the slope 80 and a part other than the slope 80.

Further, the generation unit 54 generates the input/output screen 2000 including the composite image 2500 such that the composite image 2500 includes boundaries on both sides of the plurality of slopes 80 at different positions in the moving direction of the moving object 66. This enables the user to confirm the composite image 2500 including the boundaries on both sides of each of the plurality of slopes 80 displayed on the input/output screen 2000, and to accurately confirm the positions and ranges of the plurality of slopes 80.

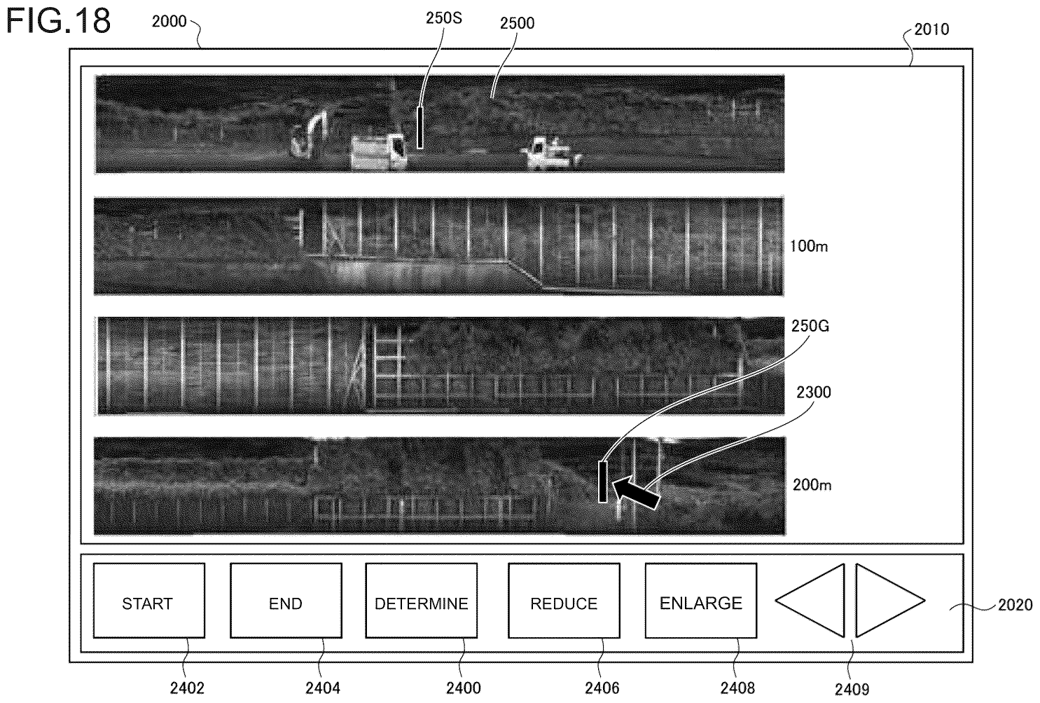

FIG. 18 is another diagram illustrating operation on an input/output screen of a condition inspection system.

FIG. 18 illustrates a state after the enlarge button 2408 is operated on the input/output screen illustrated in FIG. 17.

The composite image 2500 illustrated in FIG. 18 is enlarged as compared with the composite image 2500 illustrated in FIG. 17, each divided image indicates a captured image having a route of 50 meters along the moving direction of the moving object 6, and a divided image group in which four divided images are arranged indicates a captured image having a route of 200 meters along the moving direction of the moving object 6.

In the composite image 2500 illustrated in FIG. 17, in a case where the boundary of the slope 80 is unclear, the boundary of the slope 80 can be accurately confirmed by displaying the enlarged composite image 2500 as illustrated in FIG. 18.

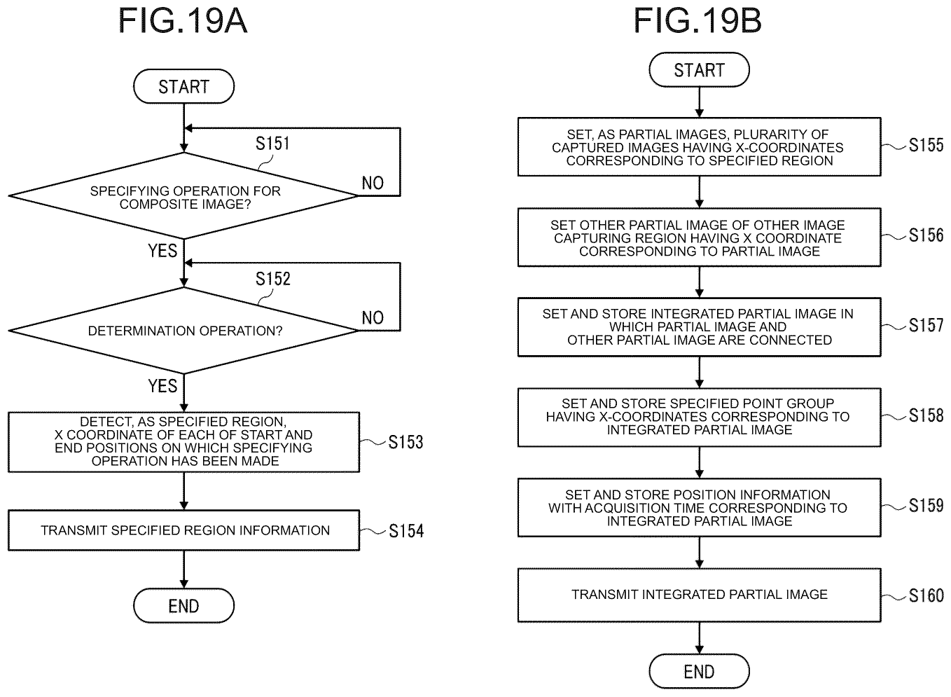

FIGS. 19A and 19B are flowcharts illustrating processing based on the operation illustrated in FIGS. 17 and 18.

FIG. 19A illustrates processing in the evaluation device 3, and FIG. 19B illustrates processing in the data management device 5.

When the start position bar 250S and the end position bar 250G are moved on the composite image 2500 by operating the pointer 2300, the receiving unit 32 of the evaluation device 3 receives the movement as specifying operation for specifying a partial region in the composite image 2500 (Step S151), and when the specified position determination button 2400 is operated, the receiving unit 32 receives the operation as determination operation for determining to specify a partial region in the composite image 2500 (Step S152).

Next, the determining unit 34 of the evaluation device 3 detects the X coordinates of the start position bar 250S and the end position bar 250G on which the specifying operation has been performed in the composite image 2500 as specified region information (Step S153).

Next, the communication unit 31 of the evaluation device 3 transmits input information related to the input operation received by the receiving unit 32 to the data management device 5 (Step S154). The input information includes specified region information indicating the specified region in the X coordinate based on the specifying operation with the pointer 2300.

The communication unit 51 of the data management device 5 receives the input information transmitted from the evaluation device 3, the setting unit 55 sets, as a partial image, a plurality of captured images between the X coordinates on both sides of the specified region in the composite image 2500 generated in Step S33 of FIG. 15 based on the specified region information included in the received input information, and the generation unit 54 performs geometric, color, brightness, and color shift correction on the partial image so that the slope 80 can be easily evaluated in a subsequent process. The storage/read unit 59 stores the partial image and the coordinates thereof in the storage unit 5000 (Step S155).

The setting unit 55 sets, as other partial images, a plurality of captured images of other image capturing regions having the X coordinates corresponding to the partial image set in Step S155 among other composite images captured by other image capturing devices, and the generation unit 54 performs geometric, color, brightness, and color shift correction on the other partial images so that the slope 80 can be easily evaluated in a subsequent process. The storage/read unit 59 stores the other partial images and the coordinates thereof in the storage unit 5000 (Step S156).

Here, the partial image set in Step S155 is, as an example, a partial image in the target region 702 imaged by the image capturing device 72 described with reference to FIG. 13, and the other partial image set in Step S156 is, as an example, a partial image in the target region 701 or 703 imaged by the image capturing device 71 or 73 described with reference to FIG. 13.

That is, in Step S155, the setting unit 55 sets a first partial image corresponding to a partial region in the first composite image based on first determination operation for determining to specify a partial region in the first composite image and, in Step S156, the setting unit 55 sets a second partial image corresponding to a partial region in the second composite image.

The setting unit 55 sets an integrated partial image obtained by connecting the partial image set in Step S155 and the other partial image set in Step S156, and the generation unit 54 performs connection processing on the integrated partial image so that the slope 80 can be easily evaluated in a subsequent process. The storage/read unit 59 stores the integrated partial image and the coordinates thereof in the storage unit 5000 (Step S157).

The setting unit 55 sets, from among the three-dimensional point group data illustrated in FIG. 11B, the three-dimensional point group data in which the X coordinates corresponds to the integrated partial image set in Step S157 as the specified point group, and the storage/read unit 59 stores the coordinates of the specified point group in the storage unit 5000 (Step S158).

The setting unit 55 sets position information with acquisition time corresponding to the integrated partial image set in Step S157 among the positioning data correlated with the captured image data in Step S33, and the storage/read unit 59 stores the position information with acquisition time corresponding to the integrated partial image in the storage unit 5000 (Step S159).

The communication unit 51 transmits integrated partial image information indicating the integrated partial image set in Step S157 to the evaluation device 3 (Step S161).

Then, as described in Step S39 of FIG. 15, the communication unit 31 of the evaluation device 3 receives the integrated partial image information transmitted from the data management device 5, and the display control unit 33 of the evaluation device 3 causes the display 306 to display the received integrated partial image.

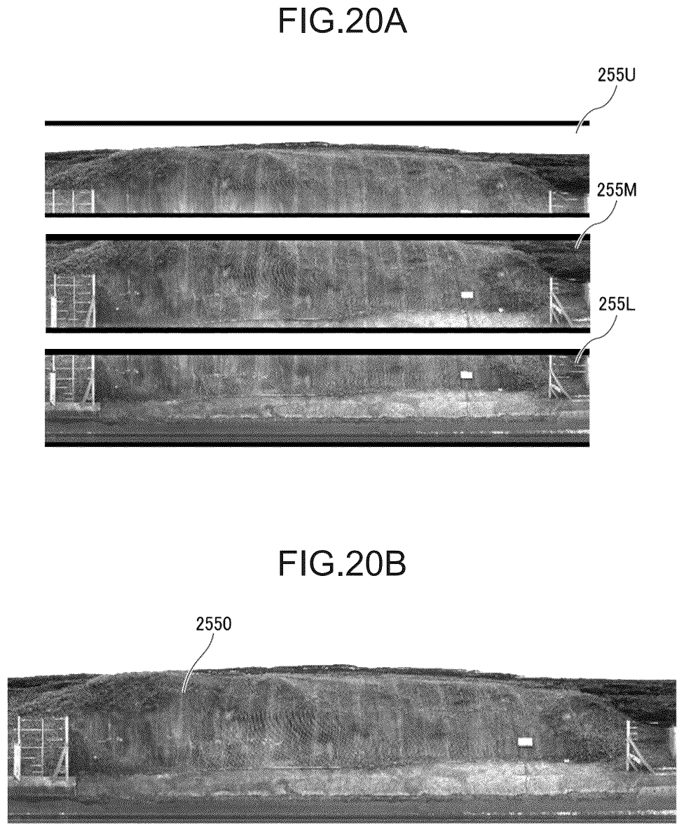

FIGS. 20A and 20B are diagrams illustrating an integrated partial image of a condition inspection system.

FIG. 20A illustrates an upper partial image 255U, a middle partial image 255M, and a lower partial image 255L.

The middle partial image 255M is a partial image in the target region 702 imaged by the image capturing device 72 described with reference to FIG. 13, and is set by the setting unit 55 in Step S155 illustrated in FIGS. 19A and 19B.

The lower partial image 255 L and the upper partial image 255U are partial images in the target regions 701 and 703 imaged by the image capturing devices 71 and 73 respectively, described with reference to FIG. 13, and are set by the setting unit 55 in Step S156 illustrated in FIGS. 19A and 19B.

The upper partial image 255U, the middle partial image 255M, and the lower partial image 255L are subjected to geometric, color, brightness, and color shift correction by the generation unit 54 so that the slope 80 can be easily evaluated in a subsequent process, as described in Steps S155 and S156 of FIGS. 19A and 19B.

FIG. 20B illustrates an integrated partial image 2550 formed by connecting the upper partial image 255U, the middle partial image 255M, and the lower partial image 255L.

As described in Step S157 in FIGS. 19A and 19B, the integrated partial image 2550 is subjected to the connection processing by the generation unit 54 so that the slope 80 can be easily evaluated in a subsequent process.

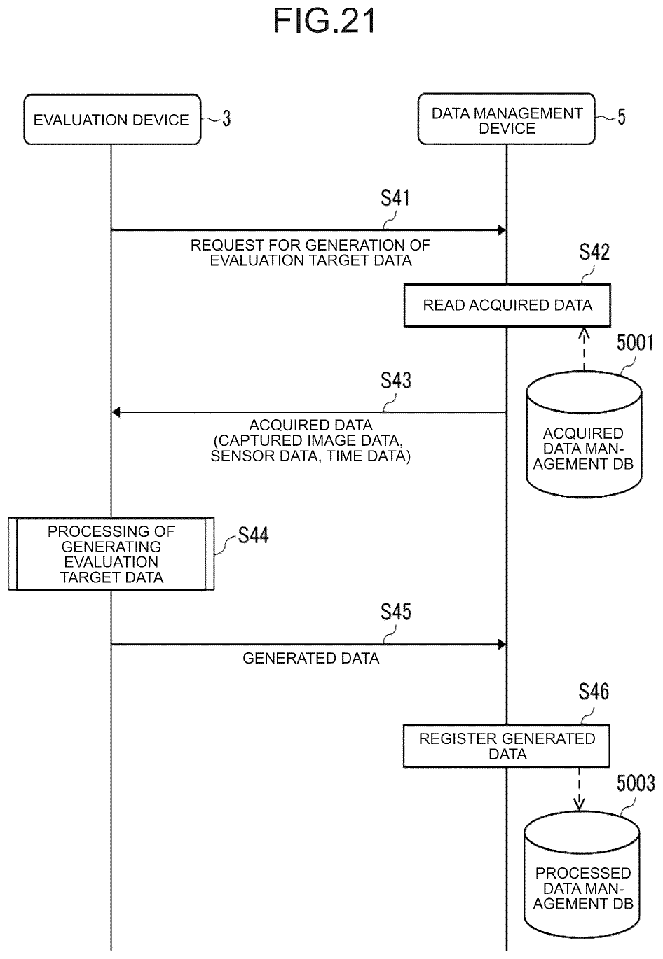

FIG. 21 is a sequence diagram illustrating a modification to the processing of generating evaluation target data.

First, when the user of the evaluation device 3 designates a folder, the receiving unit 32 of the evaluation device 3 receives selection of generation target data. Alternatively, when the user of the evaluation device 3 selects any position in the map information managed by the map data management unit 37 of the evaluation device 3, the receiving unit 32 of the evaluation device 3 may receive the selection of the position information in the map information.

The communication unit 31 of the evaluation device 3 transmits a request to generate evaluation target data to the data management device 5 (Step S41). The generation request includes the name of a folder in which data to be generated is stored. Alternatively, the request may include position information in the map information. As a result, the communication unit 51 of the data management device 5 receives the generation request transmitted from the evaluation device 3.

Next, the storage/read unit 59 of the data management device 5 searches the acquired data management DB 5001 using, as a search key, the folder name included in the generation request received in Step S41 to read the acquired data associated with the folder name included in the generation request (Step S42). Alternatively, the storage/read unit 59 searches the acquired data management DB 5001 using, as a search key, the position information included in the request received in Step S32 to read the acquired data associated with the position information included in the request.

Then, the communication unit 51 transmits the acquired data read in Step S42 to the evaluation device 3 (Step S43). The acquired data includes the captured image data, the sensor data, and the time data, whereby the communication unit 31 of the evaluation device 3 receives the acquired data transmitted from the data management device 5.

Next, the evaluation target data generation unit 35 of the evaluation device 3 generates evaluation target data using the acquired data received in Step S43 (Step S44). Specifically, the evaluation target data generation unit 35 performs inclination correction on the captured image data based on the attitude of the image capturing device 7 (moving object 6) at the time of image capturing based on the acquired sensor data of the distance sensor 8a received. In addition, the evaluation target data generation unit 35 correlates the positioning data, which is the received sensor data of the GNSS sensor 8b, with the captured image data based on the time data received. Further, the evaluation target data generation unit 35 performs processing of combining a plurality of sets of captured image data into one set of image data.

Specifically, as described with reference to FIGS. 12A to 12C, the evaluation target data generation unit 35 generates a composite image in which the captured images of the plurality of image capturing regions are connected, thereby obtaining the captured images of the target region 70 and the plurality of target regions 701A, 702A, 701B, and 702B.

Further, the evaluation target data generation unit 35 generates a composite image in which the captured images of the plurality of target regions 701A, 702A, 701B, and 702B are connected, thereby obtaining the captured image of the entire target region 70.

Here, as described above, in a case where the position of the slope 80 is unknown, the target region 70 includes the slope 80 and a region other than the slope 80.

As described above, the evaluation target data generation unit 35 has an inclination correction function for image data, a function of linking image data with position information, and a function of combining image data. The evaluation target data generation unit 35 performs image correction on the received captured image data by using the acquired data received from the data management device 5 so that the processing by the detection unit 36 and the report generation unit 38, described later, can be easily performed.

Next, the evaluation target data generation unit 35 generates an input/output screen including the composite image. The input/output screen is an example of a display screen displaying a composite image in which the images captured by dividing the target region 70 into the plurality of image capturing regions dn along the moving direction of the moving object 6 are connected together, and Step S44 is an example of a generation step.

Next, the display control unit 33 causes the display 306 to display the generated input/output screen, and the receiving unit 32 of the evaluation device 3 receives predetermined input operation by the user on the displayed input/output screen. The input operation includes determination operation for determining to specify a partial region in the composite image.

Next, the setting unit 40 updates the generated evaluation target data based on input information related to the input operation. The setting unit 40 is an example of the setting means.

Specifically, the setting unit 55 sets a partial image corresponding to a partial region, position information, and a specified point group in a three-dimensional point group corresponding to the plurality of image capturing regions dn based on specified region information specifying a partial region in the composite image, thereby updating the evaluation target data.

Next, the communication unit 31 of the evaluation device 3 transmits the generated data, which is generated and updated in Step S44, to the data management device 5 (Step S45), and the generated data includes the evaluation target data, the positioning data, and the comment that are generated by the evaluation target data generation unit 35 and updated by the setting unit 55. As a result, the communication unit 51 of the data management device 5 receives the generated data transmitted from the data evaluation device 3. Then, the data management unit 53 of the data management device 5 stores the generated data received in Step S35 in the processed data management DB 5003 (see FIG. 9B) (Step S46). Specifically, the data management unit 53 associates the evaluation target data, the positioning data, and the comment included in the generated data with one another to store the resultant in one folder.

In this manner, the evaluation system 4 performs image processing based on various data (captured image data, sensor data, and time data) acquired from the data acquisition device 9 to generate and update the evaluation target data used for evaluation of the slope condition.

### Generation of Evaluation Report

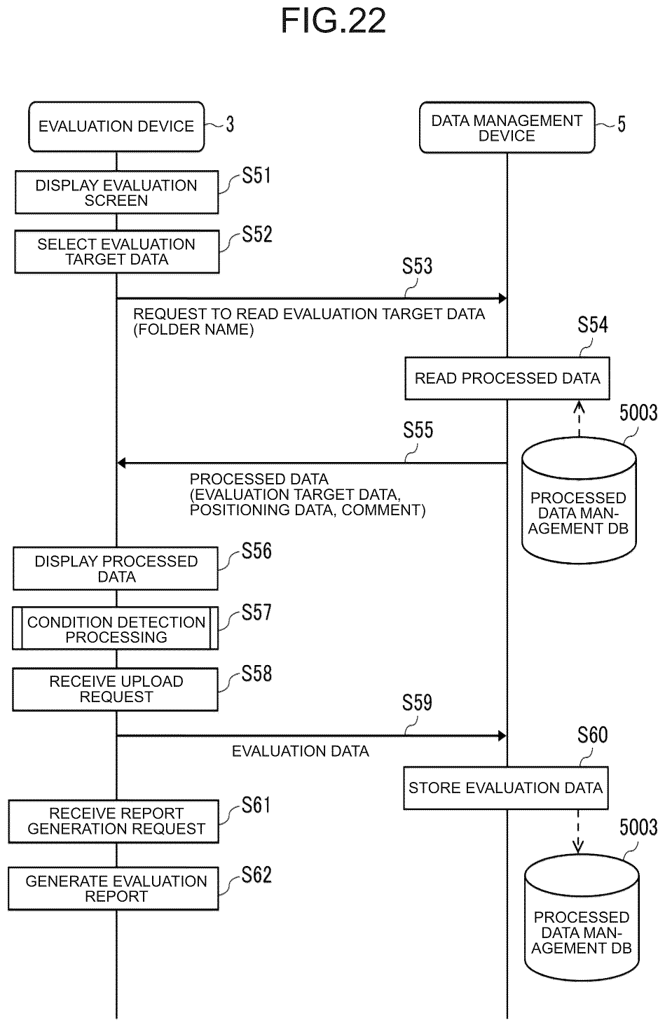

FIG. 22 is a sequence diagram illustrating an example of processing of generating a report which is an evaluation result of a slope condition.

First, the display control unit 33 of the evaluation device 3 causes the display 306 to display the evaluation screen 400 with which to perform the evaluation processing of the slope condition (Step S51).

Next, the receiving unit 32 of the evaluation device 3 receives selection of evaluation target data (Step S52).

Next, the communication unit 31 transmits a request to read the evaluation target data selected in Step S52 to the data management device 5 (Step S53). The read request includes the folder name selected in Step S52. As a result, the communication unit 51 of the data management device 5 receives the read request transmitted from the data evaluation device 3.

Next, the storage/read unit 59 of the data management device 5 searches the processed data management DB 5003 (see FIG. 9B) using, as a search key, the folder name included in the read request received in Step S53 to read the processed data associated with the folder name included in the read request (Step S54). Then, the communication unit 51 transmits the processed data read in Step S54 to the evaluation device 3 (Step S55). The processed data includes the evaluation target data, the positioning data, and the comment. As a result, the communication unit 31 of the evaluation device 3 receives the processed data transmitted from the data management device 5.

Then, the display control unit 33 of the evaluation device 3 causes the display 306 to display the processed data received in Step S54 (Step S56).

Next, the evaluation device 3 performs processing of detecting a slope condition using the evaluation target data (Step S57). Details of the processing of detecting a slope condition will be described later.

The receiving unit 32 receives a request to upload an evaluation result (Step S58). Then, the communication unit 31 uploads (transmits) the evaluation result to the data management device 5 (Step S59). As a result, the communication unit 51 of the data management device 5 receives the evaluation data transmitted from the evaluation device 3. Then, the data management unit 53 of the data management device 5 registers the evaluation data received in Step S59 in the processed data management DB 5003 (see FIG. 9B) (Step S60). In this case, the data management unit 53 stores the evaluation data in one folder in association with the evaluation target data or the like that has been evaluated.

The receiving unit 32 also receives a request to generate an evaluation report (Step S61). Then, the report generation unit 38 generates an evaluation report based on the detection result of the slope condition by the detection unit 36 (Step S62). The report generation unit 38 generates an evaluation report by arranging evaluation data indicating the above-described evaluation result based on inspection guidelines issued by a national government or the like or a format according to a request from a road administrator.

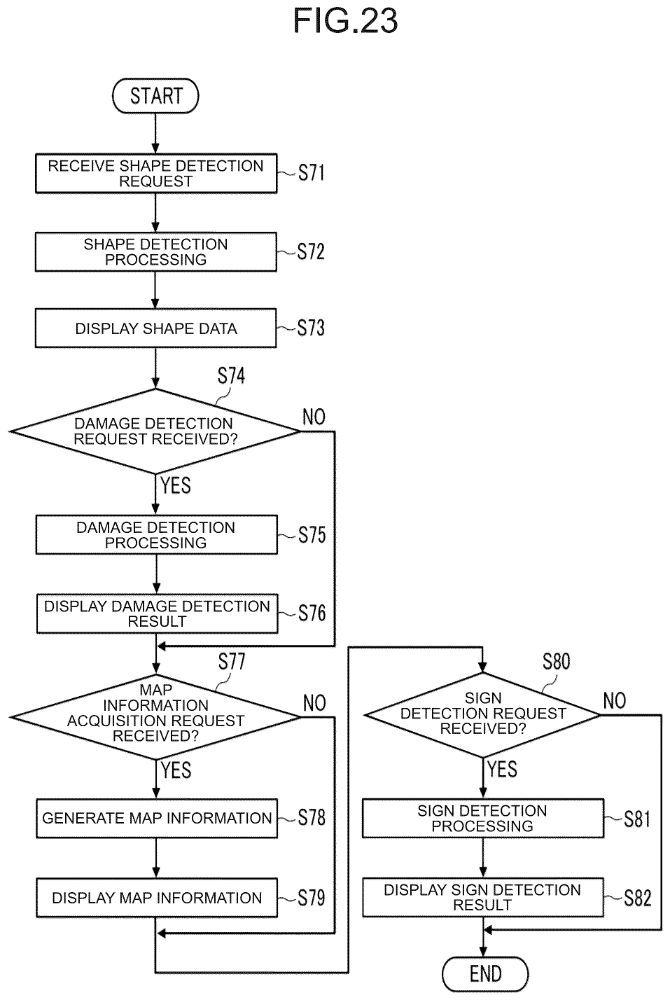

Here, the processing of detecting the slope condition will be described in detail with reference to FIG. 23. FIG. 23 is a flowchart illustrating an example of processing of detecting a slope condition.

First, the receiving unit 32 receives a shape detection request (Step S71). Next, the detection unit 36 performs shape detection processing using the evaluation target data (Step S72). Here, the shape data indicating the shape of the slope is represented by three-dimensional information such as extension, height, and inclination angle of the slope, position information, and the like. The extension of the slope is the length of the slope in the plan view (the length in the depth direction of the transverse section in which the inclination of the slope can be seen). The shape data also includes information indicating a type of the slope, namely, indicating whether the slope is a natural slope or an earthwork structure. In a case where the slope is an earthwork structure, the shape data also includes information on the type of the earthwork structure. The type of the civil engineering structure is, for example, a retaining wall, a slope frame, a sprayed mortar, presence or absence of an anchor, embankment, or the like.

Specifically, the detection unit 36 detects the extension, the height, and the inclination angle of the slope based on the image data and the three-dimensional data included in the evaluation target data. In addition, the detection unit 36 detects the type of the slope indicated in the image that is the evaluation target data using the condition type management DB 3001 (see FIG. 7). In this case, the detection unit 36 detects the type of the slope by image matching processing using training images indicated in the condition type management table.

Next, the display control unit 33 causes the display 306 to display the shape data, which is the detection result in Step S72 (Step S73). In Steps S71 to S73 described above, “structure information detection” processing may be performed instead of the “shape detection” processing.

In this case, the receiving unit 32 receives a request to detect structure information (Step S71). Next, the detection unit 36 performs the structure information detection processing using the evaluation target data (Step S72). Then, the display control unit 33 causes the display 306 to display the structure information detection information, which is the detection result in Step S72 (Step S73).

Here, the structure information includes additional information on the structure in addition to the shape data described above. Specifically, the detection unit 36 detects, based on the image data and the three-dimensional data included in the evaluation target data, the type of the slope indicated in the image that is the evaluation target data and the type of the additional information on the slope using the condition type management DB 3001 (see FIGS. 7 and 8). In this case, the detection unit 36 detects the type of the slope and the additional information on the slope by image matching processing using training images indicated in the condition type management table.

Next, if the receiving unit 32 receives a damage detection request for requesting damage detection in the slope condition (YES in Step S74), then the processing proceeds to Step S75. On the other hand, if the receiving unit 32 does not receive a damage detection request (NO in Step S74), then the processing proceeds to Step S77. The detection unit 36 performs processing of detecting damage to the slope condition on the evaluation target data (Step S75).

Here, in the damage detection processing in the slope condition, the presence or absence of deformation on the slope or the degree of the deformation is detected as damage data indicating the degree of damage to the slope. The degree of deformation indicates a degree of deterioration of deformation, and is the width of a crack, the size of separation, the size of a bulge, or the like. The detection unit 36 detects the presence or absence of deformation on the slope or the degree of the deformation based on the image data and the sensor data included in the evaluation target data. (Example of Evaluation Step) The detection unit 36 also detects whether the degree of the deformation exceeds a predetermined value by using a predetermined detection formula for the degree of deterioration of deformation or the like. In this case, the detection unit 36 determines whether the width of the crack is equal to or larger than a certain value, the size of the peeling is equal to or larger than a certain value, the bulge is large, or the like.

Then, in Step S38 illustrated in FIG. 15, the data management unit 53 of the data management device 5 stores the coordinates of the damage location and the type of the damage in the processed data management DB 5003 in correlation with the coordinates corresponding to the X-axis direction and the Y-axis direction in the captured image data 7A illustrated in FIGS. 11A and 11B.

Next, the display control unit 33 causes the display 306 to display a display screen indicating the damage detection result in Step S75 (Step S76).

The display control unit 33 also causes the display 306 to display a cross-sectional image. The cross-sectional image shows a cross-sectional view of the slope to be evaluated, which is drawn based on the shape data detected by the detection unit 36. Since the shape data is detected using the sensor data from the distance sensor 8a (three-dimensional sensor), the shape data can be represented in detail including three-dimensional information such as the inclination or height of the slope, which cannot be calculated only from a two-dimensional image.

Next, if the receiving unit 32 receives a map information acquisition request (YES in Step S77), then the processing proceeds to Step S78. On the other hand, if the receiving unit 32 does not receive a map information acquisition request (NO in Step S77), then the processing ends. The detection unit 36 generates map information indicating the position of the slope condition to be evaluated (Step S78). Specifically, the detection unit 36 generates map information in which an image indicating the position of the slope is added to a position (north latitude and east longitude) indicated by the positioning data acquired in Step S55 corresponding to map data available using a predetermined service or application provided by an external WEB server or the like. The map data provided from an external WEB server or the like is managed by the map data management unit 37.

Next, the display control unit 33 causes the display 306 to display map information 490 generated in Step S78 (Step S79).

If the receiving unit 32 receives a sign detection request for requesting to detect a sign of damage to the slope condition (YES in Step S80), then the processing proceeds to Step S81. On the other hand, if the receiving unit 32 does not receive a sign detection request (NO in Step S80), then the processing ends. The detection unit 36 performs processing of detecting a sign of the slope condition on the evaluation target data (Step S81).

In the condition inspection system 1, conventionally, when deformation of a slope is found, the condition and the position of the slope are identified. However, the viewpoint of measuring information indicating a sign of a position of slope deformation before the deformation occurs on the slope is not known. Here, in the damage sign detection processing of the slope condition, a sign of slope deformation is detected based on measurement data on the slope including peripheral data indicating a physical quantity around the slope as sign data indicating a sign of damage to the slope.

The measurement data includes the captured image data obtained by capturing an image of the slope by the image capturing device 7 or the sensor data obtained by measuring the slope by a three-dimensional sensor such as the distance sensor 8a.

The peripheral data includes measurement data on an object other than the slope, and the object other than the slope includes at least one of seepage, earth and sand, rocks, and plants.

In a case where the measurement data on the slope includes peripheral data indicating seepage occurring on the slope surface, there is a possibility that accumulated water is exerting pressure from the back side of the slope, and thus, it is detected that there is a sign of deformation of the slope. Specifically, it is not limited to the presence or absence of seepage, but it is detected that there is a sign of deformation of the slope depending on the amount, type, and location of the seepage.

In a case where the measurement data on the slope includes peripheral data indicating plants and moss growing on the slope surface, there is a possibility that seepage occurs and accumulated water is exerting pressure from the back side of the slope, and thus, it is detected that there is a sign of deformation of the slope. Specifically, it is not limited to the presence or absence of plants and moss, but it is detected that there is a sign of deformation of the slope depending on the amount, type, and location of the plants and moss.

In a case where the measurement data on the slope includes peripheral data indicating rockfall, earth and sand around the slope, there is a possibility that an abnormality has occurred on the back side and upper side of the slope, and thus, it is detected that there is a sign of deformation of the slope. Specifically, it is not limited to the presence or absence of rockfall, earth and sand, but it is detected that there is a sign of deformation of the slope depending on the amount, type, and location of the rockfall, earth and sand.

In a case where the measurement data on the slope includes peripheral data indicating blockages in a drain hole, a pipe, a drainage channel of a berm, and so on, there is a possibility that drainage from the back side to the front side of the slope is hindered and accumulated water is exerting pressure from the back side of the slope, and thus, it is detected that there is a sign of deformation of the slope. Specifically, it is not limited to the presence or absence of blockage, but it is detected that there is a sign of deformation of the slope depending on the amount, type, and location of a foreign matter that causes the blockage.

In a case where a drain hole, a pipe, or a drainage channel of a berm itself is damaged, it is detected as deformation of the slope, but blockage in a drain hole, a pipe, a drainage channel of a berm, or the like is not detected as deformation of the slope, but is detected as a sign of deformation of the slope.

The measurement data on an object other than the slope may be detected as a sign of deformation of the slope based on a combination of a plurality of sets of measurement data. Specifically, even if peripheral data indicating that seepage is present only in a small part of the slope, in a case where the entire slope is covered with moss, it is estimated that the seepage normally spreads over the entire slope surface, and it is detected that there is a sign of deformation of the slope.

In addition, the peripheral data includes measurement data of a physical quantity other than an object, and the measurement data of a physical quantity other than an object includes measurement data on light.

In a case where the measurement data on the slope includes peripheral data indicating good sun exposure, it is detected that there is a sign of deformation of the slope in combination with the measurement data on an object other than the slope described above. Specifically, in a case where moss grows on a slope that is easily dried due to good sun exposure, there is a possibility that seepage occurs and accumulated water is exerting pressure from the back side of the slope, and thus, it is detected that there is a sign of deformation of the slope.

In the damage sign detection processing of the slope condition, a comment on a sign of slope deformation is generated based on measurement data on the slope including peripheral data indicating a physical quantity around the slope as sign data indicating a sign of damage to the slope. Then, in Step S38 illustrated in FIG. 15, the data management unit 53 of the data management device 5 stores the coordinates of the location showing a sign of deformation and the comment in the processed data management DB 5003 in correlation with the coordinates corresponding to the X-axis direction and the Y-axis direction in the captured image data 7A illustrated in FIGS. 11A and 11B.

Specifically, based on the captured image data which is an example of the acquired peripheral data, the training images of the condition type management table illustrated in FIG. 8 are referred to, and a comment indicating the type of the physical quantity around the slope such as seepage and the amount and position thereof is generated. As an example, a comment “moss rate is 30%, and moss is mostly distributed around 3 to 20 meters above the starting point.” is generated.

Next, the display control unit 33 causes the display 306 to display a display screen indicating the sign detection result in Step S81 (Step S82).

The display control unit 33 also causes the display 306 to display a cross-sectional image. As described above, the evaluation system 4 detects, as the evaluation of the slope condition, the shape of the slope including the three-dimensional information, the degree of damage to the slope, the sign of deformation of the slope, and the position of the slope to be evaluated.

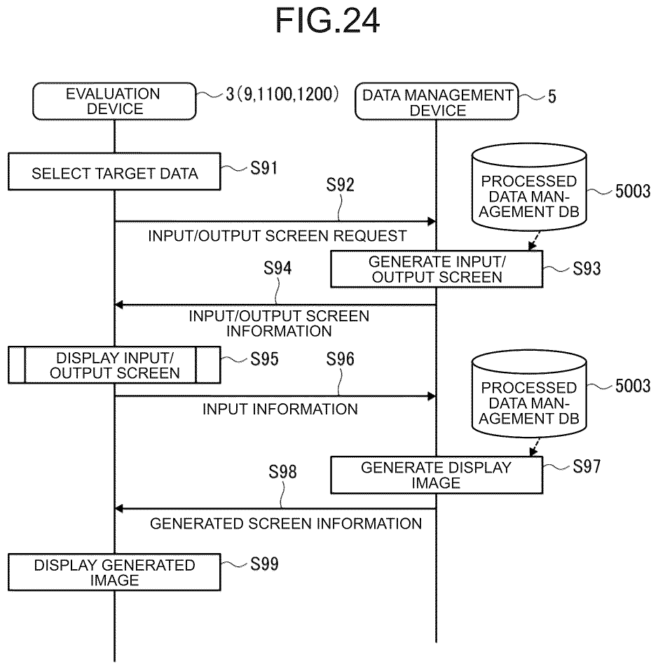

FIG. 24 is a sequence diagram illustrating an example of display processing in a condition inspection system.

Hereinafter, the sequence between the evaluation device 3 and the data management device 5 will be described, and the same applies to the sequence between the data acquisition device 9, the communication terminal 1100 as well as the communication terminal 1200, and the data management device 5.

When a user of the evaluation device 3 designates a folder, the receiving unit 32 of the evaluation device 3 receives selection of target data (Step S91). Alternatively, when the user of the evaluation device 3 selects any position in the map information managed by the map data management unit 37 of the evaluation device 3, the receiving unit 32 of the evaluation device 3 may receive the selection of the position information in the map information.

Next, the communication unit 31 transmits a request for an input/output screen related to the target data selected in Step S91 to the data management device 5, and the communication unit 51 of the data management device 5 receives the request transmitted from the evaluation device 3 (Step S92). The request includes the folder name selected in Step S91. Alternatively, the request may include position information in the map information.

Next, the storage/read unit 59 of the data management device 5 searches the processed data management DB 5003 (see FIG. 9B) using, as a search key, the folder name included in the request received in Step S92 to read the image data associated with the folder name included in the request. Alternatively, the storage/read unit 59 searches the acquired data management DB 5001 using, as a search key, the position information included in the request received in Step S92 to read the image data associated with the position information included in the request.

The generation unit 54 of the data management device 5 generates an input/output screen including the image data based on the image data read out by the storage/read unit 59 (Step S93). The input/output screen is a screen with which to receive instruction operation for instructing generation of an image indicating a specified position in a luminance image indicating the slope.

The communication unit 51 transmits input/output screen information related to the input/output screen generated in Step S93 to the evaluation device 3, and the communication unit 31 of the evaluation device 3 receives the input/output screen information transmitted from the data management device 5 (Step S94). Step S94 is an example of a determination receiving screen transmission step.

Then, the display control unit 33 of the evaluation device 3 causes the display 306 to display the input/output screen received in Step S94 (Step S95). The receiving unit 32 of the evaluation device 3 receives predetermined input operation by the user on the displayed input/output screen. The input/output operation includes instruction operation for instructing generation of an image indicating a specified position in a luminance image indicating the slope. Step S95 is an example of a receiving step.

The communication unit 31 transmits input information related to the input operation received by the receiving unit 32 to the data management device 5, and the communication unit 51 of the data management device 5 receives the input information transmitted from the evaluation device 3 (Step S96). The input/output information includes instruction information for instructing generation of an image indicating a specified position in a luminance image indicating the slope.

The generation unit 54 of the data management device 5 generates a display image using the image data read by the storage/read unit 59 in Step S93 based on the received input information (Step S97). The display image includes a surface display image including a surface image indicating the surface of the slope and a surface position image indicating a specified position in the surface image, and a cross-section display image including a cross-sectional image indicating the cross-section of the slope and a cross-sectional position image indicating a specified position in the cross-sectional image. Step S97 is an example of an image generation step.

The communication unit 51 of the data management device 5 transmits the display image generated in Step S97 to the evaluation device 3, and the communication unit 31 of the evaluation device 3 receives the display image transmitted from the data management device 5 (Step S98). Step S98 is an example of a display image transmission step.

The display control unit 33 of the evaluation device 3 causes the display 306 to display the display image received in Step S98 (Step S99). Step S99 is an example of a display step.

Although FIG. 24 illustrates the sequence related to the display processing between the evaluation device 3 and the data management device 5, the evaluation device 3 may independently execute the display processing.

In such a case, Steps S92, 94, 96, and 98 related to data transmission and reception are omitted, and the evaluation device 3 can perform display processing similar to that in FIG. 24 by executing Steps S91, 93, 95, 97, and 99 independently. Similarly to the evaluation device 3, the data acquisition device 9, the communication terminal 1100, and the communication terminal 1200 can independently execute the display processing.

Generation of Surface Display Image Based on Operation for Designating Specified position

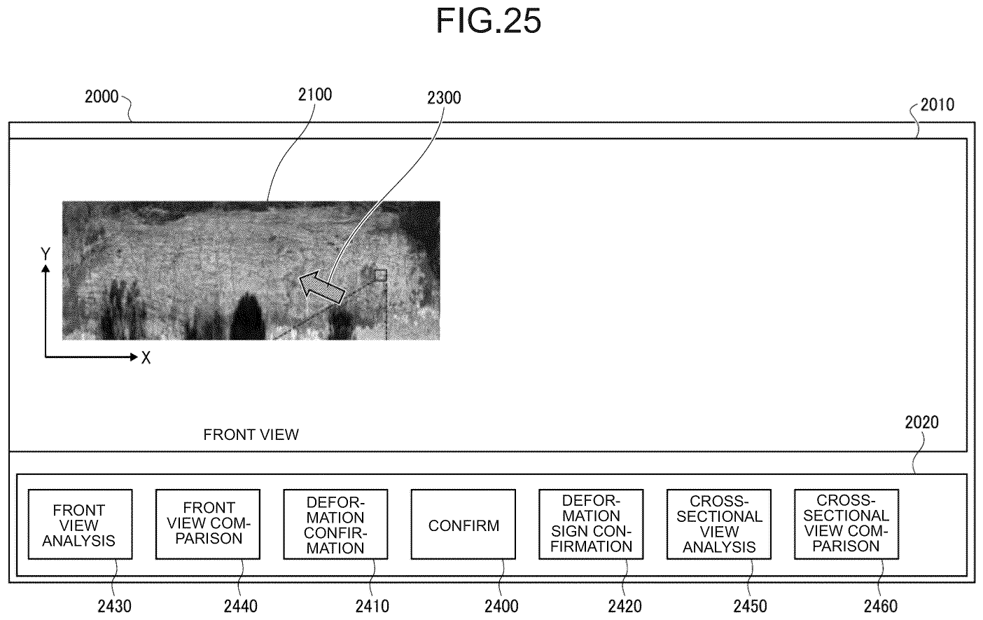

FIG. 25 is a diagram illustrating operation on a display screen of a condition inspection system. FIG. 25 illustrates the input/output screen 2000 displayed on the display 306 of the evaluation device 3 in Step S95 of the sequence diagram illustrated in FIG. 24, and the same applies to the input/output screen 2000 displayed on each of the displays of the data acquisition device 9, the communication terminal 1100, and the communication terminal 1200.

The display control unit 33 of the evaluation device 3 displays an input/output screen 2000 including a specific receiving screen 2010 for receiving designation operation for designating a specified position in a luminance image indicating a slope and a determination receiving screen 2020 for receiving determination operation for determining to generate an image indicating the specified position in the slope.

The display control unit 33 displays a surface image 2100 indicating the surface of the slope on the specific receiving screen 2010 and displays a pointer 2300 operated with the pointing device 312 on the surface image 2100.

The surface image 2100 is a luminance image read from the captured image data illustrated in FIG. 9A in Step S93 of FIG. 24, and the display control unit 33 displays the surface image 2100 in correlation with the X-axis direction and the Y-axis direction indicated in the captured images 1 and 2 illustrated in FIG. 10 and the captured image data 7A illustrated in FIGS. 11A and 11B.

The display control unit 33 displays a determination receiving screen 2020 including a specified position determination button 2400, a deformation confirmation button 2410, a deformation sign confirmation button 2420, a front view analysis button 2430, a front view comparison button 2440, a cross-sectional view analysis button 2450, and a cross-sectional view comparison button 2460. The deformation confirmation button 2410, the deformation sign confirmation button 2420, the front view analysis button 2430, the front view comparison button 2440, the cross-sectional view analysis button 2450, and the cross-sectional view comparison button 2460 are buttons used to instruct generation of an image indicating a specified position on the slope, with the position of a part satisfying a predetermined condition in the surface image 2100 or a cross-sectional image 2200 set as the specified position.

The specified position determination button 2400 is a button used to determine a specified position on the slope designated on the specific receiving screen 2010 and to give an instruction to generate an image indicating the specified position on the slope. The specified position determination button 2400 may determine not only the specified position designated on the specific receiving screen 2010 but also the specified position specified by the determining unit 52 or the like and displayed on the specific receiving screen 2010.

The deformation confirmation button 2410 is a button used to instruct generation of an image indicating a specified position on the slope with a position indicating deformation on the slope as the specified position. The deformation sign confirmation button 2420 is a button used to instruct generation of an image indicating a specified position on the slope with a position indicating a sign of deformation on the slope as the specified position.

The front view analysis button 2430 is a button used to instruct generation of an image indicating a specified position on the slope with a part obtained by analyzing the surface image 2100 as the specified position. The front view comparison button 2440 is a button used to instruct generation of an image indicating the specified position on the slope with a part obtained by comparing the surface image 2100 with another image as the specified position.

The cross-sectional view analysis button 2450 is a button used to instruct generation of an image indicating a specified position on the slope with a part obtained by analyzing a cross-sectional image described below as the specified position. The cross-sectional view comparison button 2460 is a button used to instruct generation of an image indicating the specified position on the slope with a part obtained by comparing the cross-sectional image with another image as the specified position.

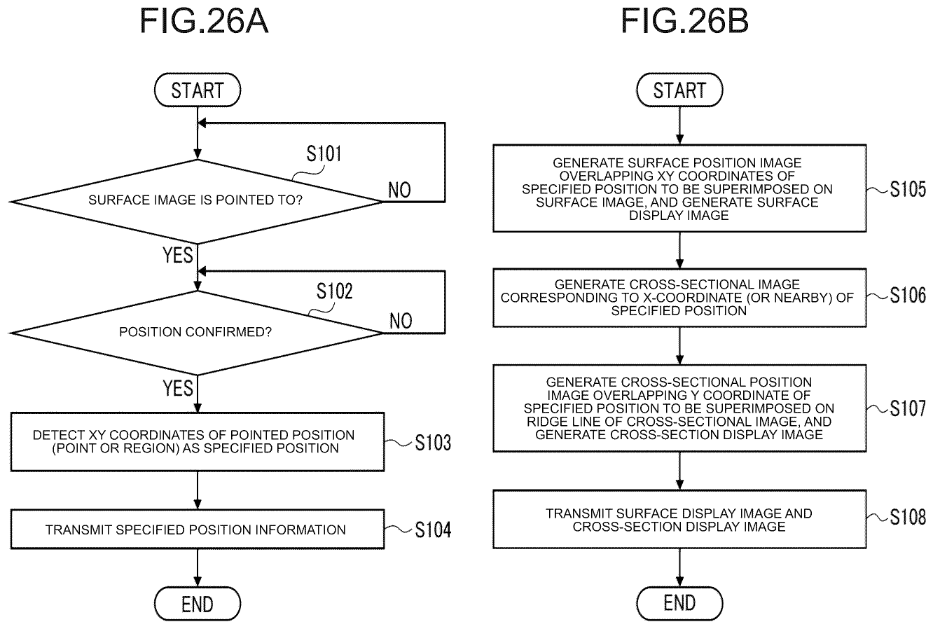

FIGS. 26A and 26B are flowcharts illustrating processing based on the operation illustrated in FIG. 25. FIG. 26A illustrates processing in the evaluation device 3, and FIG. 26B illustrates processing in the data management device 5.

When a predetermined position on the surface image 2100 is pointed to by the pointer 2300, the receiving unit 32 of the evaluation device 3 receives the pointing operation (Step S101), and when the specified position determination button 2400 is operated, the receiving unit 32 receives the operation (Step S102).

Next, the determining unit 34 of the evaluation device 3 detects the XY coordinates of the pointed position in the surface image 2100 as the specified position (Step S103). The specified position may indicate a point in the XY coordinates or may indicate a region therein.

Next, the communication unit 31 of the evaluation device 3 transmits input information related to the input operation received by the receiving unit 32 to the data management device 5 (Step S104). The input information includes designation information for designating a specified position in the XY coordinates based on pointing operation by the pointer 2300, and instruction information for instructing generation of an image indicating the specified position on the slope based on operation of the specified position determination button 2400.

The communication unit 51 of the data management device 5 receives the input information transmitted from the evaluation device 3, and the generation unit 54 generates a surface position image overlapping the XY coordinates of the specified position by superimposing the surface position image on the surface image using the image data illustrated in FIG. 11A based on the instruction information and the designation information included in the received input information, to thereby generate a surface display image (Step S105). The surface position image does not necessarily completely match the XY coordinates of the specified position, and only needs to overlap the XY coordinates of the specified position.

Subsequently, the generation unit 54 generates a cross-sectional image corresponding to the X coordinate of the specified position using the image data illustrated in FIG. 11A and the ranging data illustrated in FIG. 11B (Step S106). In a case where the ranging data illustrated in FIG. 11B does not include the X coordinate of the specified position, a cross-sectional image is generated based on data near the X coordinate of the specified position included in the ranging data illustrated in FIG. 11B.

Note that, although the generation unit 54 generates, in Step S106, the cross-sectional image of the cross section including the Z-axis direction and the vertical direction illustrated in FIG. 10, the generation unit 54 may generate a cross-sectional image of the cross section including the direction inclined from the Z-axis direction and the vertical direction or a cross-sectional image of the cross section including the direction inclined from the Z-axis direction.

The generation unit 54 generates a cross-sectional position image overlapping the Y coordinate of the specified position by superimposing the cross-sectional position image on the ridge line of the cross-sectional image, to thereby generate a cross-section display image (Step S107).

The communication unit 51 transmits, to the evaluation device 3, the surface display image generated in Step S105 and the cross-section display image generated in Step S107 (Step S108).

Then, as illustrated in Steps S98 and S99 of FIG. 24, the communication unit 31 of the evaluation device 3 receives the surface display image and the cross-section display image transmitted from the data management device 5, and the display control unit 33 of the evaluation device 3 causes the display 306 to display the received surface display image and cross-section display image.

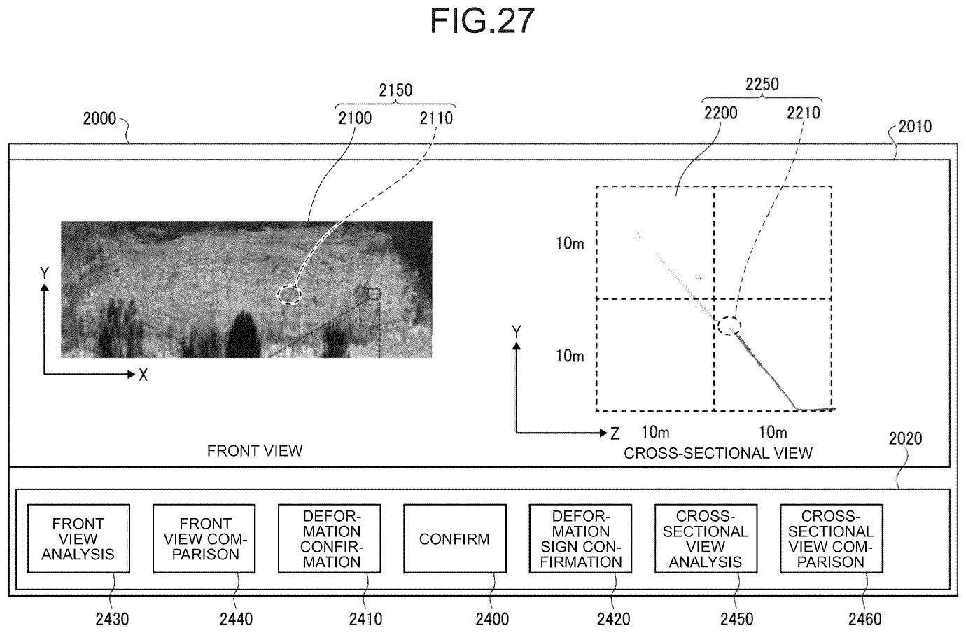

FIG. 27 is an example of a display screen after the processing illustrated in FIGS. 26A and 26B. FIG. 27 illustrates the input/output screen 2000 displayed on the display 306 of the evaluation device 3 in Step S99 of the sequence diagram illustrated in FIG. 24.

The display content of the determination receiving screen 2020 is the same as that in FIG. 25, but the display content of the specific receiving screen 2010 is different from that in FIG. 25.

The display control unit 33 of the evaluation device 3 displays, on the specific receiving screen 2010, a surface display image 2150 including the surface image 2100 indicating the surface of the slope and a surface position image 2110 indicating a specified position in the surface image 2100, and a cross-section display image 2250 including the cross-sectional image 2200 indicating the cross-section of the slope and a cross-sectional position image 2210 indicating a specified position in the cross-sectional image 2200.

The display control unit 33 displays the cross-sectional image 2200 in correlation with the Y-axis direction and the Z-axis direction illustrated in FIG. 10.

The user can appropriately evaluate and confirm the condition of the specified position by comparing the surface position image 2110 and the cross-sectional position image 2210.

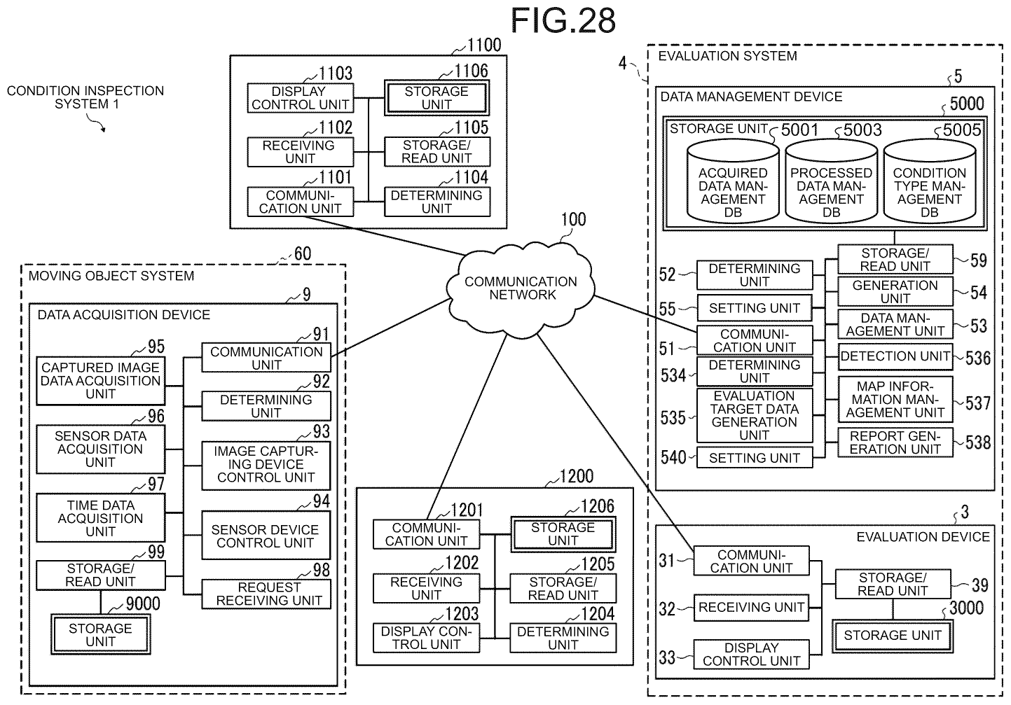

FIG. 28 is a diagram illustrating a modification to the functional configuration of the condition inspection system.

In the modification illustrated in FIG. 28, instead of the determining unit 34, the evaluation target data generation unit 35, the detection unit 36, the map data management unit 37, the report generation unit 38, and the setting unit 40 included in the evaluation device 3 in FIG. 6, the data management device 5 includes a determining unit 534, an evaluation target data generation unit 535, a detection unit 536, a map data management unit 537, a report generation unit 538, and a setting unit 540.

The determining unit 534, the evaluation target data generation unit 535, the detection unit 536, the map data management unit 537, the report generation unit 538, and the setting unit 540 illustrated in FIG. 28 have the same function or are the same means as the determining unit 34, the evaluation target data generation unit 35, the detection unit 36, the map data management unit 37, the report generation unit 38, and the setting unit 40 illustrated in FIG. 6, respectively.

The storage unit 5000 of the data management device 5 includes a condition type management DB 5005 instead of the condition type management DB 3001 included in the storage unit 3000 of the evaluation device 3 as illustrated in FIG. 6.

The condition type management DB 5005 illustrated in FIG. 28 manages data similar to that in the condition type management DB 3001 illustrated in FIG. 6.

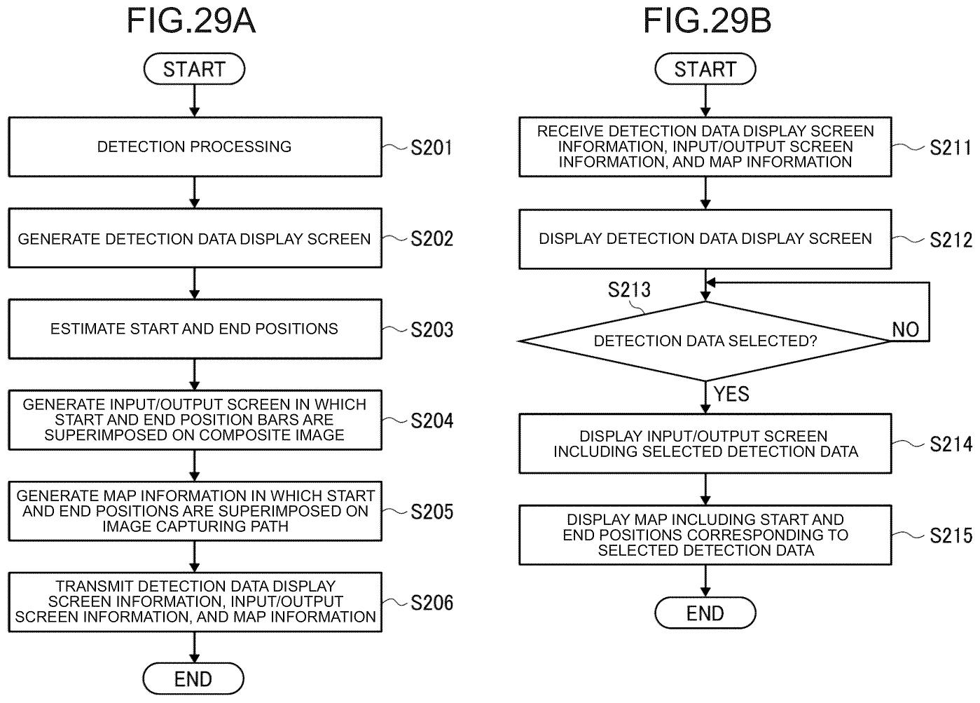

FIGS. 29A and 29B are flowcharts illustrating processing in the modification illustrated in FIG. 28.

FIG. 29A illustrates processing in the data management device 5.

The detection unit 536 uses the condition type management DB 3001 (see FIG. 7) to detect the type of the slope indicated in the composite image illustrated in FIGS. 16A and 16B, similarly to the processing of the detection unit 36 in Step S72 of FIG. 23 (Step S201). The detection unit 536 can detect a plurality of types of slopes.

The generation unit 54 generates a detection data display screen including the detection data detected in Step S201 (Step S202). The generation unit 54 can generate a detection data display screen including a plurality of sets of detection data.

The detection unit 536 estimates a boundary between the slope 80 and a part other than the slope 80, that is, a start position and an end position of the slope 80 in the moving direction of the moving object 6 based on the detection data detected in Step S201 (Step S203). The detection unit 536 can estimate a plurality of combinations of the start position and the end position. Here, in the embodiment illustrated in FIG. 6, the generation unit 54 identifies a part where a boundary between the slope 80 and a part other than the slope 80 probably exists, but in the modification illustrated in FIG. 28, the detection unit 536 estimates a boundary between the slope 80 and a part other than the slope 80.

The generation unit 54 generates an input/output screen in which the start position bar and the end position bar are superimposed on the composite image based on the start position and the end position estimated in Step S203, similarly to the input/output screen 2000 illustrated in FIGS. 17 and 18 (Step S204). The generation unit 54 can generate an input/output screen in which a plurality of combinations of the start position bar and the end position bar is superimposed on the composite image.

The generation unit 54 generates, based on the start position and the end position estimated in Step S203, a map screen in which an image indicating the start position and an image indicating the end position are superimposed on the map data, similarly to the map information generated in Step S78 of FIG. 23 (Step S205). The generation unit 54 can generate a map screen in which a plurality of combinations of the image indicating the start position and the image indicating the end position are superimposed.

The communication unit 51 transmits, to the evaluation device 3, detection data display screen information indicating the detection data display screen generated in Step S202, input/output screen information indicating the input/output screen generated in Step S204, and map screen information indicating the map screen generated in Step S205 (Step S206).

The communication unit 51 can transmit these pieces of information also to the data acquisition device 9, the communication terminal 1100, and the communication terminal 1200.

FIG. 29B illustrates processing in the evaluation device 3. The processing in the data acquisition device 9, the communication terminal 1100, and the communication terminal 1200 is similar to the processing in the evaluation device 3.

The communication unit 31 receives the detection data display screen information, the input/output screen information, and the map screen information transmitted from the data management device 5 (Step S211).

The display control unit 33 causes the display 306 to display the detection data display screen indicated in the detection data display screen information received in Step S211 (Step S212).

When the receiving unit 32 receives selection operation for selecting one or a plurality of sets of detection data included in the detection data display screen (Step S213), the display control unit 33 causes the display 306 to display the input/output screen indicated in the input/output screen information received in Step S211 so as to include the detection data selected in Step S213 (Step S214).

Specifically, as illustrated in FIG. 16B, in a case where the input/output screen includes the plurality of divided image groups 250A and 250B, the display control unit 33 causes the display 306 to display the divided image group including the detection data.

Further, the input/output screen displayed in Step S214 is similar to the input/output screen 2000 illustrated in FIG. 17. In FIG. 17, when the user operates the start position designation button 2402 and the end position designation button 2404, the display control unit 33 displays the start position bar 250S and the end position bar 250G at any positions on the composite image 2500, whereas in the input/output screen displayed in Step S214, the display control unit 33 displays the start position bar 250S and the end position bar 250G at the start position and the end position estimated in Step S203 of FIG. 29A on the composite image 2500.

Here, the start position bar 250S is an example of a first marker indicating an estimated position of a boundary at one end of the slope 80 with a part other than the slope 80, and the end position bar 250G is an example of a second marker indicating an estimated position of a boundary at the other end of the slope 80 with a part other than the slope 80.

Next, the display control unit 33 causes the display 306 to display the map screen indicated in the map screen information received in Step S211 so as to include the detection data selected in Step S213 (Step S215).

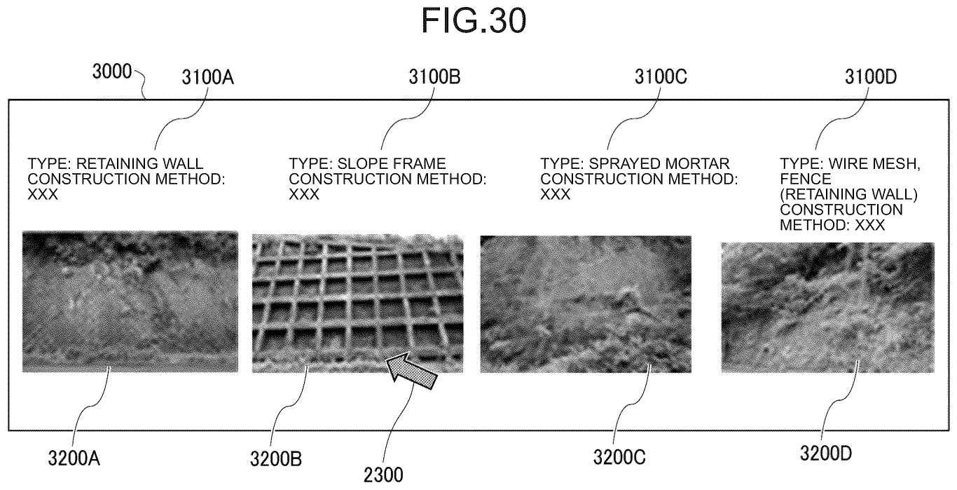

FIG. 30 is a diagram illustrating an example of a detection data display screen in the modification illustrated in FIG. 28.

FIG. 30 illustrates a detection data display screen 3000 displayed on the display 306 of the evaluation device 3 in Step S212 of the flowchart illustrated in FIGS. 29A and 29B, and the same applies to a detection data display screen displayed on each of the displays of the data acquisition device 9, the communication terminal 1100, and the communication terminal 1200. The detection data display screen 3000 is an example of a type display screen.

The display control unit 33 of the evaluation device 3 causes the display 306 to display the detection data display screen 3000 including text information 3100A to 3100D indicating the plurality of sets of detection data detected in Step S201 of FIG. 29A and image information 3200A to 3200D. The text information 3100A to 3100D includes text information related to the type of the slope and the construction method. The text information 3100A to 3100D is an example of type information.

When the pointer 2300 points to a predetermined position on any one of the text information 3100A to 3100D and the image information 3200A to 3200D, the receiving unit 32 of the evaluation device 3 receives operation for selecting the pointed detection data as illustrated in Step S213 of FIG. 29B.

The display control unit 33 may switch and display the detection data display screen 3000 on the input/output screen 2000 illustrated in FIG. 17, or may display the detection data display screen 3000 on a separate window.

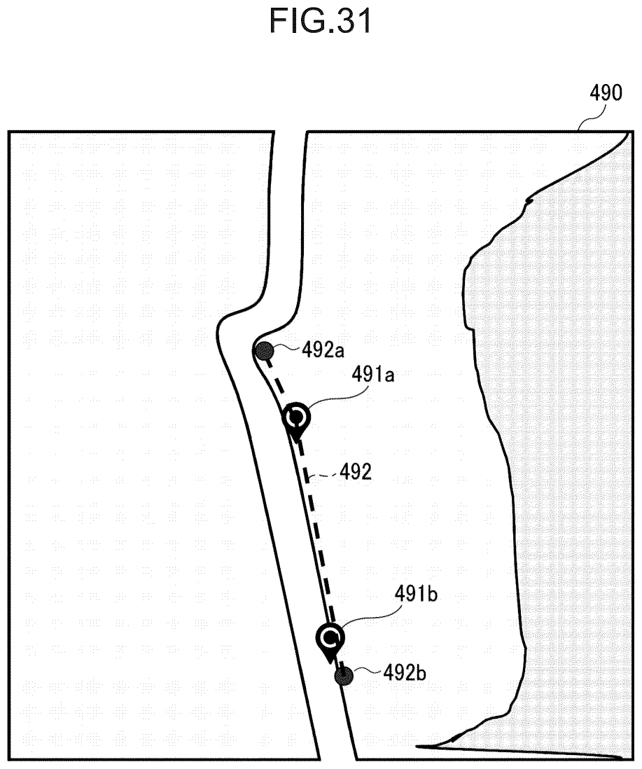

FIG. 31 is a diagram illustrating an example of a map screen in the modification illustrated in FIG. 28.

FIG. 31 illustrates a map screen 490 displayed on the display 306 of the evaluation device 3 in Step S215 of the flowchart illustrated in FIGS. 29A and 29B, and the same applies to a map screen displayed on each of the displays of the data acquisition device 9, the communication terminal 1100, and the communication terminal 1200.

The display control unit 33 causes the display 306 to display the map screen 490 including an image capturing path 492 including an image capturing start position 492a and an image capturing end position 492b, a start position 491a of the slope 80 in the moving direction of the moving object 6, and an end position 491b of the slope 80 in the moving direction of the moving object 6. The start position 491a is an example of one end of the slope 80, and the end position 491b is an example of the other end of the slope 80.

The image capturing path 492 corresponds to the image capturing position of the composite image described in FIGS. 16A and 16B and the like, and includes the image capturing position of the detection data selected in Step S213 of FIG. 29B.

In addition, the start position 491a and the end position 491b correspond to the start position and the end position estimated in Step S203 of FIG. 29A, respectively.

The display control unit 33 may switch and display the map screen 490 on the input/output screen 2000 illustrated in FIG. 17, or may display the map screen 490 on a separate window.

### Modification to Moving Object System

### First Modification

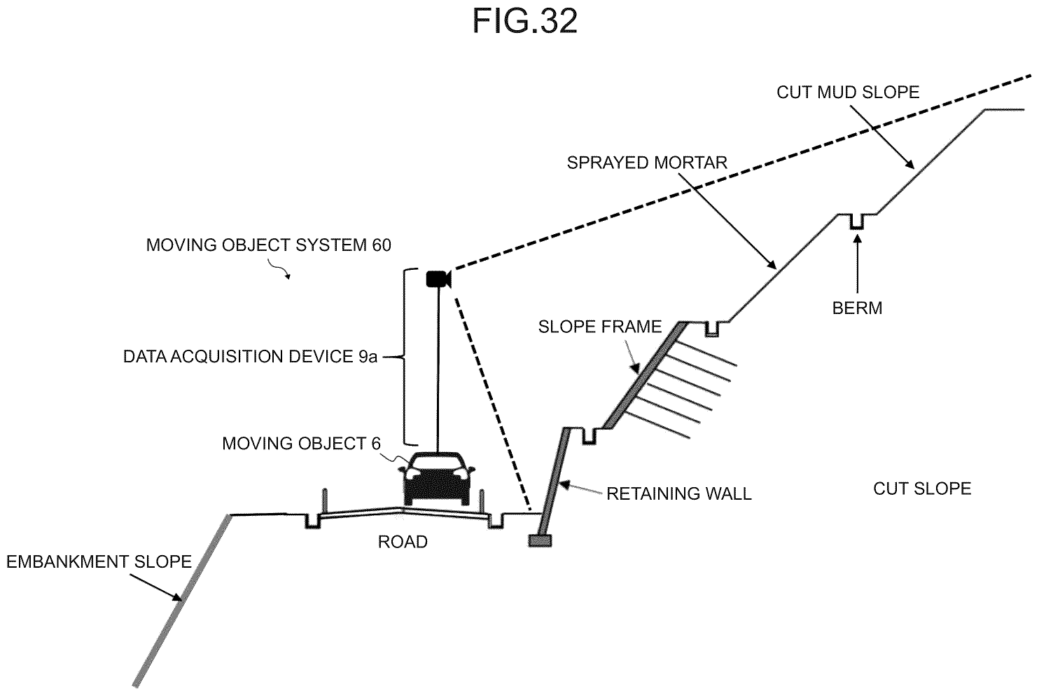

Next, a modification to the moving object system 60 will be described with reference to FIGS. 32 to 34. First, FIG. 32 is a diagram illustrating an example of how a slope condition is inspected using a moving object system according to the first modification. A moving object system 60 according to the first modification is a system in which a data acquisition device 9 is fixed to a pole installed on an upper surface of a moving object 6 in order to enable image capturing at high locations.

In the embodiment described above, the height of the image capturing device 7 from the ground is low, which makes it difficult to perform image capturing of a berm above a retaining wall, a berm above a slope frame, or a berm above a sprayed mortar as illustrated in FIG. 32. In addition, as illustrated in FIG. 32, berms of the current road earthwork structures are not covered, and there is a possibility that a defect that a water passage is clogged due to accumulation of withered leaves or the like occurs, and therefore periodic cleaning is required. In view of this, for example, even in a case where it is difficult for a person to climb a slope and confirm the degree of clogging of a water passage, by using the moving object system 60 according to the first modification which enables image capturing at high locations, it is possible to make such a confirmation by image capturing processing during the traveling operation of the moving object 6, which significantly improves the inspection efficiency.

### Second Modification

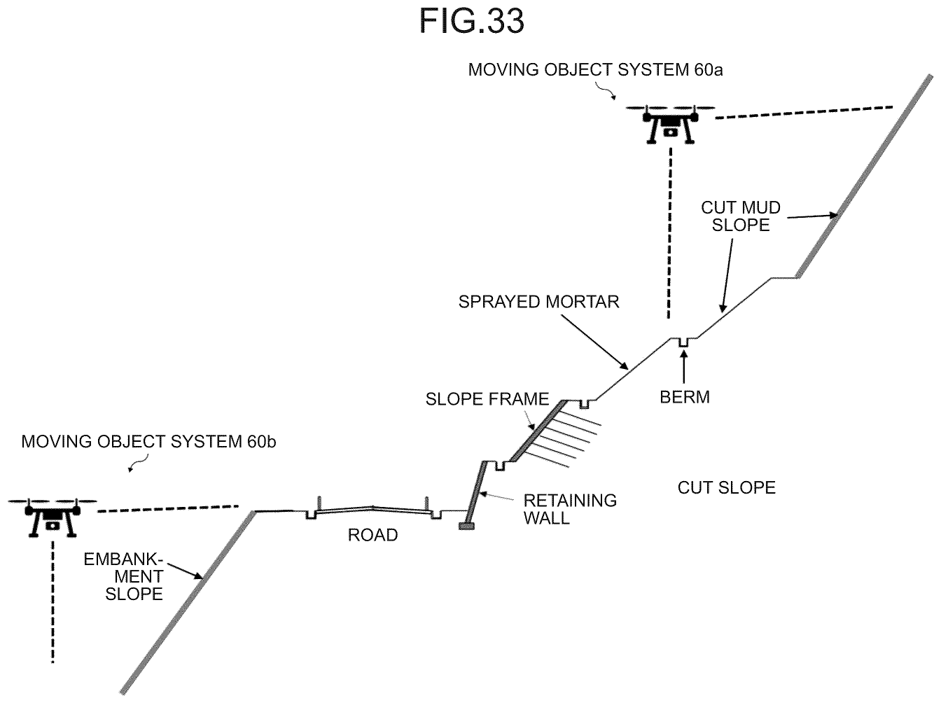

FIG. 33 is a diagram illustrating an example of how a slope condition is inspected using a moving object system according to the second modification. A moving object system 60 (60a, 60b) according to the second modification is, for example, a system using a drone equipped with a data acquisition device 9 as an example of a moving object 6 in order to capture an image of an embankment slope at a high location or below a road side which cannot be imaged by the image capturing device with a pole according to the first modification.

The drone as the moving object 6 is equipped with not only an image capturing device 7 but also a data acquisition device 9 including a sensor device such as a distance sensor 8a, a GNSS sensor 8b, or an angle sensor 8c. This makes it possible to evaluate a condition of a high location or embankment that cannot be evaluated using a vehicle as the moving object 6. In particular, embankments and high locations are places where it is difficult for human to go for close visual inspection, so, image capturing with the drone as in the second modification is desired. In addition, slopes of embankments and high locations are often covered with a lot of vegetation such as trees and grasses. Therefore, the data acquisition device 9 preferably includes the image capturing device 7 capable of capturing a wide-angle image.

As described in Step S123 of FIG. 25A, it is also desirable for the drone to travel so that the moving line at the time of image capturing does not deviate from the moving line scheduled in Step S122 as much as possible.

### Third Modification

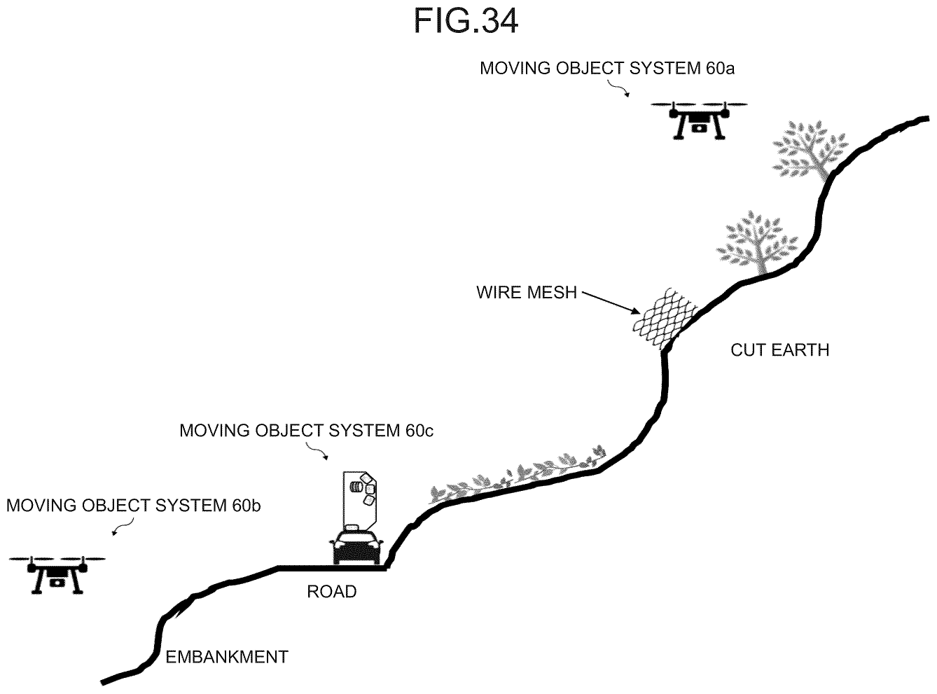

FIG. 34 is a diagram illustrating an example of how a slope condition is inspected using a moving object system according to the third modification. As illustrated in FIG. 34, the slope has a complicated structure unlike a tunnel or a bridge which is a structure on a road.

For example, the slope is not flat but undulating (for example, an earthwork structure in which mortar is sprayed to a cliff), is covered with vegetation, or covered with a wire mesh. Therefore, a moving object system 60 (60a, 60b, 60c) according to the third modification includes, as a sensor device 8, a spectrum camera, an infrared camera, or an expanded depth of field (EDof) camera capable of acquiring wavelength information in order to distinguish the shape of a slope from an object such as a plant or a wire mesh.

In addition, the moving object system 60 according to the third modification preferably has a configuration in which not only a tool for distinguishing the shape of the slope but also a lighting device is mounted on the data acquisition device 9 so that an image of the slope can be captured under various conditions such as weather and sun exposure. The lighting device in this case is preferably a line lighting device that irradiates an area corresponding to the image capturing range by the image capturing device 7, or a time-sharing lighting device synchronized with the image capturing device 7 and the sensor device 8.

Further, in order to process data acquired by the moving object system 60 according to the third modification, the evaluation target data generation unit 35 of the evaluation device 3 preferably has an image processing function such as a camera shake correction function, a focal depth correction function (blur correction function), a distortion correction function, or a contrast enhancement function so as not to overlook even small deformation. In addition, the evaluation target data generation unit 35 preferably has a function of deleting noise that conceals deformation on an earthwork structure such as grass, moss, or a wire mesh, and a function of distinguishing between a shadow of grass or the like and deformation such as a crack. As described above, by using the moving object system 60 according to the third modification, the condition inspection system 1 can accurately evaluate the slope condition even at a part having a complicated structure or a part where grass, moss, a wire mesh, or the like is present.

### Summary

### First Aspect

The data management device 5 according to an embodiment of the present invention includes the generation unit 54 that generates the input/output screen 2000 displaying the composite image 2500 including the boundary between the slope 80 and a part other than the slope 80 in the moving direction of the moving object 6, the composite image 2500 being acquired by connecting the captured images pn, captured by the image capturing device 7 installed in the moving object 6, of the target region 70 including the slope 80 and a part other than the slope 80 with the target region 70 divided into the plurality of image capturing regions dn along the moving direction of the moving object 6.

Here, the data management device 5 is an example of an information processing device, the slope 80 is an example of a target object, the input/output screen 2000 is an example of a display screen, and the generation unit 54 is an example of a generation means.

This makes it possible to confirm the composite image 2500 including the boundary between the slope 80 and a part other than the slope 80 displayed on the input/output screen 2000, and to confirm a position of an unknown slope 80.

### First Aspect—2

In the first aspect, the generation unit 54 generates the input/output screen 2000 such that the composite image 2500 includes boundaries between the plurality of slopes 80 at different positions and parts other than the plurality of slopes 80 in the moving direction of the moving object 66.

This enables confirming the positions of the plurality of slopes 80.

### First Aspect—3

In the first aspect or the first aspect-2, the generation unit 54 generates the input/output screen 2000 such that the length of the composite image 2500 in the moving direction of the moving object 66 corresponding to the moving distance of the moving object 66 differs according to the resolution of the display 306 or the like on which the input/output screen 2000 is displayed.

This improves the visibility of the composite image 2500 including the boundaries on both sides of the slope 80 displayed on the input/output screen 2000, and enables confirming the position of the slope 80 easily.

### Second Aspect

In the first aspect, the generation unit 54 generates the input/output screen 2000 displaying the start position bar 250S and the end position bar 250G, which are examples of markers indicating the estimated position of the boundary, superimposed on the composite image 2500.

This enables the user to easily recognize the estimated position of the boundary using the start position bar 250S and the end position bar 250G.

### Third Aspect

In the second aspect, the generation unit 54 generates the input/output screen 2000 displaying, by one screen or one line, the first marker indicating the estimated position of the boundary at one end of the slope 80 and the second marker indicating the estimated position of the boundary at the other end of the slope 80. The start position bar 250S is an example of the first marker, and the end position bar 250G is an example of the second marker.

This enables the user to easily recognize the boundary at one end of the slope 80 and the boundary at the other end thereof by one screen or one line.

### Fourth Aspect

In any one of the first to third aspects, the generation unit 54 generates the detection data display screen 3000 displaying the text information 3100A to 3100D indicating the estimated types of the slope 80. The text information 3100A to 3100D is an example of the type information, and the detection data display screen 3000 is an example of the type display screen. This enables the user to confirm the estimated type of the slope 80.

### Fifth Aspect

In the fourth aspect, the display control unit 33 of the evaluation device 3 causes the display 306 to display the captured image capturing an image of the slope 80 corresponding to the text information 3100A to 3100D selected in the composite image 2500 based on the selection operation for selecting the text information 3100A to 3100D or the image information 3200A to 3200D corresponding to the text information 3100A to 3100D displayed on the display 306.

This enables the user to confirm a captured image capturing an image of the slope 80 corresponding to the estimated type of the slope 80 in the composite image 2500.

### Sixth Aspect

In any one of the first to fifth aspects, the data management device 5 includes the setting unit 55 that sets the partial image 255 corresponding to a partial region based on the determination operation on the specified position determination button 2400 with which to determine to specify the partial region in the composite image 2500. The setting unit 55 is an example of a setting means.

This enables specifying a partial region corresponding to the slope 80 and enables setting the partial image 255 corresponding to the slope 80.

### Seventh Aspect

In any one of the first to sixth aspects, the generation unit 54 generates the input/output screen 2000 so as to display, side by side, the divided images of each of the plurality of divided images 250A1 to Am obtained by dividing the composite image 2500.

As a result, even when the length of the composite image 2500 or the slope 80 in the moving direction of the moving object 6 is long, the position of the slope 80 can be easily confirmed on one input/output screen 2000.

### Eighth Aspect

In any one of the first to seventh aspects, the generation unit 54 generates the input/output screen 2000 so as to display the composite image 2500 with a resolution lower than that of each captured image pn captured with the target region divided into the plurality of image capturing regions dn stored in the acquired data management DB 5001.

As a result, the processing speed at the time of generating or displaying the input/output screen 2000 is increased, and the communication load at the time of transmitting and receiving the input/output screen information indicating the input/output screen 2000 is reduced.

### Ninth Aspect

In any one of the first to eighth aspects, the target region 70 includes a first target region and a second target region which are different ranges in a direction intersecting the moving direction of the moving object 66, and
the generation unit 54 generates the input/output screen 2000 including at least one of a first composite image and a second composite image. The first composite image is obtained by connecting the first captured images pn obtained by capturing images with the first target region divided into the plurality of first image capturing regions dn along the moving direction of the moving object 66. The second composite image is obtained by connecting the second captured images pn obtained by capturing images with the second target region divided into the plurality of second image capturing regions dn along the moving direction of the moving object 66.

As a result, the position of the slope 80 can be confirmed by checking the first composite image and the second composite image that show different ranges in the direction intersecting the moving direction of the moving object 66.

### Tenth Aspect

In the ninth aspect, the data management device 5 includes the setting unit 55 that sets a first partial image corresponding to a partial region in the first composite image based on first determination operation for determining to specify a partial region in the first composite image, and sets a second partial image corresponding to a partial region in the second composite image.

As a result, based on the first determination operation for setting the first partial image corresponding to a partial region in the first composite image 2500, the second partial image corresponding to a partial region in the second composite image 2500 can be set.

### Eleventh Aspect

In the tenth aspect, the setting unit 55 sets an integrated partial image in which the first partial image and the second partial image are connected.

### Twelfth Aspect

In the sixth aspect, the setting unit 55 sets position information corresponding to a partial region based on the determination operation.

### Thirteenth Aspect

In the sixth aspect or the twelfth aspect, the setting unit 55 sets a specified point group corresponding to a partial region for the three-dimensional point group corresponding to the plurality of image capturing regions dn based on the determination operation.

### Fourteenth Aspect

An information processing method according to an embodiment of the present invention includes executing a generation step of generating the input/output screen 2000 displaying the composite image 2500 including the boundary between the slope 80 and a part other than the slope 80 in the moving direction of the moving object 6 by dividing the target region 70 including the slope 80 and a part other than the slope 80 into the plurality of image capturing regions dn along the moving direction of the moving object 66 and connecting the captured images pn captured by the image capturing device 7 installed in the moving object 66.

### Fifteenth Aspect

An information processing method according to an embodiment of the present invention includes an image capturing step of capturing an image of the target region 70 including the slope 80 and a part other than the slope 80 with the target region 70 divided into the plurality of image capturing regions dn along the moving direction of the moving object 66 by the image capturing device 7 installed in the moving object 6, and a generation step of generating the input/output screen 2000 displaying the composite image 2500 including the boundary between the slope 80 and a part other than the slope 80 in the moving direction of the moving object 66 by connecting the captured images pn obtained by the image capturing with the target region 70 divided into the plurality of image capturing regions dn.

### Sixteenth Aspect

A program according to an embodiment of the present invention causes a computer to execute the information processing method according to the fourteenth aspect or fifteenth aspect.

### Seventeenth Aspect

The condition inspection system 1 according to an embodiment of the present invention includes the moving object system 60 having the moving object 66 and the image capturing device 7 installed in the moving object 66 and the data management device 5 for processing an image captured by the moving object system 60, in which the moving object system 60 captures an image, using the image capturing device 7, of the target region 70 including the slope 80 and a part other than the slope 80 with the target region 70 divided into the plurality of image capturing regions dn along the moving direction of the moving object 66, and the data management device 5 includes the generation unit 54 that generates the input/output screen 2000 displaying the composite image 2500 including the boundary between the slope 80 and a part other than the slope 80 in the moving direction of the moving object 6 by connecting the captured images pn obtained by the image capturing with the target region 70 divided into the plurality of image capturing regions dn.

Here, the condition inspection system 1 is an example of the information processing system, and the moving object system 60 is an example of the image capturing system.

### Eighteenth Aspect

In the seventeenth aspect, the evaluation device 3, the communication terminal 1100 or 1200 capable of communicating with the data management device 5 is further included, and the data management device 5 further includes the communication unit 51 that transmits input/output screen 2000 information indicating the input/output screen 2000 to the terminal device, and the evaluation device 3, the communication terminal 1100 or 1200 includes the communication units 31, 1101, and 1201 that receive the input/output screen 2000 information transmitted from the data management device 5, and the display control units 33, 1103, and 1203 that display the input/output screen 2000 on the display 306.

### Supplements

Each function of the embodiments described above can be implemented by one or a plurality of processing circuits. Here, the “processing circuit” in the present embodiment includes a processor programmed to execute each function using software, such as a processor implemented by an electronic circuit, and devices such as an application specific integrated circuit (ASIC), a digital signal processor (DSP), a field programmable gate array (FPGA), a system on a chip (SOC), a graphics processing unit (GPU), and a conventional circuit module designed to execute the functions described above.

In addition, the various tables of the embodiments described above may be generated by a learning effect of machine learning, and the table does not have to be used by classifying data of each associated item by machine learning. Here, the machine learning is a technology that allows a computer to acquire human-like learning capabilities, and refers to a technology in which a computer autonomously generates algorithms necessary for determination such as data identification from learning data imported previously, and applies the algorithms to new data to make prediction. A learning method for machine learning may be any one of supervised learning, unsupervised learning, semi-supervised learning, reinforcement learning, and deep learning, or may be a combination of these learning methods, and any learning method for machine learning may be used.

In addition, the various tables of the embodiment described above may be generated using an image processing method. Examples of the image processing method include edge detection, line detection, and binarization processing. Similarly, when audio is dealt with, an audio conversion method such as Fourier transform may be used.

Although the evaluation system, the condition inspection system, the evaluation method, and the program according to one embodiment of the present invention have been described so far, the present invention is not limited to the above-described embodiment, and can be changed within the scope that can be conceived by those skilled in the art, such as addition, change, or deletion of other embodiments, and any aspect is included in the scope of the present invention as long as the operation and effect of the present invention are achieved.

According to an embodiment, it is possible to confirm a position of a target part in an image captured by an image capturing device installed in a moving object.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

1. An information processing device, comprising:
generation circuitry configured to connect captured images obtained by capturing, by a camera installed in a moving object, a target region including a target object and a part other than the target object while dividing the target region into a plurality of image capturing regions along a moving direction of the moving object, to generate a display screen displaying a composite image including a boundary between the target object and the part other than the target object in the moving direction of the moving object.

2. The information processing device according to claim 1, wherein;
the generation circuitry means is further configured to generate the display screen to include displaying a marker indicating an estimated position of the boundary so as to be superimposed on the composite image.

3. The information processing device according to claim 2, wherein:
the generation circuitry is further configured to generate the display screen which includes, by one screen or one line, a first marker indicating an estimated position of the boundary at one end of the target part and a second marker indicating an estimated position of the boundary at another end of the target part.

4. The information processing device according to claim 1, wherein:
the generation circuitry generates a type display screen including type information indicating an estimated type of the target object.

5. The information processing device according to claim 4, wherein:
based on selection operation for selecting the type information or image information corresponding to the type information, a captured image capturing the target object corresponding to the selected type information or the selected image information in the composite image is displayed on a display.

6. The information processing device according to claim 1, further comprising:
setting circuitry configured to set a partial image corresponding to a partial region, based on a determination operation for determining the partial region in the composite image.

7. The information processing device according to claim 1, wherein:
the generation circuitry is further configured to generate the display screen so as to display, side by side, a plurality of divided images obtained by dividing the composite image.

8. The information processing device according to claim 1, wherein:
the generation circuitry is further configured to generate the display screen so as to display the composite image with a resolution lower than each captured image captured while dividing the target region into the plurality of image capturing regions stored in a memory.

9. The information processing device according to claim 1, wherein:
the target region includes a first target region and a second target region comprising different ranges in a direction intersecting the moving direction of the moving object, and
the generation circuitry is further configured to generate a first composite image acquired by connecting first captured images obtained by capturing images while dividing the first target region into a plurality of first image capturing regions along the moving direction of the moving object, and a second composite image acquired by connecting second captured images obtained by capturing images while dividing the second target region into a plurality of second image capturing regions along the moving direction of the moving object,
the display screen including at least one of the first composite image and the second composite image.

10. The information processing device according to claim 9, further comprising:
setting circuitry configured to set a first partial image corresponding to a partial region in the first composite image, and configured to set a second partial image corresponding to the partial region in the second composite image, based on first determination operation for determining the partial region in the first composite image.

11. The information processing device according to claim 10, wherein:
the setting circuitry is further configured to set an integrated partial image in which the first partial image and the second partial image are connected.

12. The information processing device according to claim 6, wherein:
the setting circuitry is further configured to set position information corresponding to the partial region based on the determination operation.

13. The information processing device according to claim 6, wherein:
the setting circuitry is further configured to set a specified point group corresponding to the partial region for a three-dimensional point group corresponding to the plurality of image capturing regions, based on the determination operation.

14. The information processing device according to claim 12, wherein:
the setting circuitry is further configured to set a specified point group corresponding to the partial region for a three-dimensional point group corresponding to the plurality of image capturing regions, based on the determination operation.

15. An information processing method, comprising:
connecting captured images obtained by capturing, by a camera installed in a moving object, a target region including a target object and a part other than the target object while dividing the target region into a plurality of image capturing regions along a moving direction of the moving object, to generate a display screen displaying a composite image including a boundary between the target object and the part other than the target object in the moving direction of the moving object.

16. A non-transitory computer-readable medium including programmed instructions that cause a computer to execute the information processing method according to claim 15.

17. An information processing system comprising:
an image capturing system including a moving object and a camera installed in the moving object; and
information processing circuitry configured to process an image captured by the image capturing system,
wherein:
the image capturing system is configured to capture, by the camera, a target region including a target object and a part other than the target object while dividing the target region into a plurality of image capturing regions along a moving direction of the moving object, and
the information processing circuitry includes generation circuitry configured to connect captured images captured while dividing the target region into the plurality of image capturing regions, to generate a display screen displaying a composite image including a boundary between the target object and the part other than the target object in the moving direction of the moving object.

18. The information processing system according to claim 17, further comprising:
a terminal capable of communicating with the information processing circuitry,
wherein:
the information processing circuitry further includes a transmitter to transmit display screen information indicating the display screen to the terminal, and
the terminal includes:
a receiver to receive the display screen information transmitted from the information processing circuitry; and
display control circuitry configured to display the display screen on a display.
